(19) United States
(12) Patent Application Publication
(10) Pub. No.: US 2017/0291069 A1
(43) Pub. Date: Oct. 12, 2017

(54) MULTI-SENSORY AND INTERDISCIPLINARY BALANCE PLATFORM TRAINING APPARATUS

(71) Applicant: ROGER JAMES ZAKARIASEN, Minneapolis, MN (US)

(72) Inventor: ROGER JAMES ZAKARIASEN, Minneapolis, MN (US)

(21) Appl. No.: 15/435,019

(22) Filed: Feb. 16, 2017

Related U.S. Application Data
(60) Provisional application No. 62/309,807, filed on Mar. 17, 2016.
(60) Provisional application No. 62/295,706, filed on Feb. 16, 2016.

(51) Int. Cl. A63B 26/00; A63B 22/18; A63F 13/214; A63B 21/00

(52) U.S. Cl. CPC A63B 26/003; A63B 21/0004; A63B 22/18; A63F 13/214; A63B 2022/0033

(57) ABSTRACT

This invention encompasses a balance board/wobbling platform type of apparatus which uniquely enables integrative training in two distinct realms not normally combined—namely, directly integrating physical BALANCE with expressive MUSICALITY such that MUSIC itself can actually be created by the BALANCING adjustments of the user/s. In a direct sort of way, the user of the Giant Musical Wobble Board is actually enabled to create MUSIC by means of BALANCE. This unique empowerment is effected by means of toned bells (or other sounding devices) being affixed in an easily moveable manner (in the preferred embodiment) to the surface of a wobbling platform—which (in the preferred embodiment) is of a substantive size—so that the user through minute balancing adjustments can direct a rolling ball to contact/sound the toned bells. A “hook and loop” based attachment system is utilized (in the preferred embodiment) whereby the toned bells—and/or other props—can quickly and easily by removed and/or repositioned so as to enable a vast variety of changes and thus maximally interest the user and maximally challenge the user's balance and adaptability. Moreover, the way wherein this product uniquely makes it possible to integrate BALANCE and MUSIC with ACADEMIC INFORMATION, gives this particular balance board a surpassing degree of interest-generating power and INTEGRATIVE, INTERDISCIPLINARY breadth.

### BACKGROUND

Today there are many devices on the market geared to challenge and thereby improve the balance ability—and hence physical fitness and athleticism—of the user. These-balance training devices may do what they do well, but they are quite limited in their appeal and in their profitability to the user. They pretty much only appeal to sports and fitness minded individuals; and they pretty much only serve to increase the user's balance skills. What is needed is a balance training product that has a greater capacity to challenge and keep the interest of the user. Moreover, and most importantly perhaps, there is a need for a balance-training product which—while doing all of the above—can also leverage the POWER OF MULTI-DISCIPLINE INTEGRATION to increase the BREADTH of profitability for all involved.

The main shortcoming of the available balance training devices is that they have a narrow range of variability. As a result boredom too easily results and interest in using these devices too quickly fades. And because they tend to ONLY serve to improve the user's balancing skills, they do little if anything to challenge and advance the user in any other area/s. Due to this limited focus—i.e. on balance alone—they tend to have only a sports and fitness application and thus pretty much only appeal to those interested in sports and fitness improvement, and even for these only until boredom sets in. Due to these limitations, the available balance training devices are severely restricted as to the broadness of their appeal and the number of participants who will be benefited thereby. And—most importantly perhaps —those with little interest in sports and fitness end up missing out on the benefits that could be obtained from participating in balance training. There is a need for a balance-training device that can appeal to and keep the interest of a much broader range of users as well as challenge and advance the skills and abilities of its users beyond balance alone.

Another related problem is securing toned bells suitable for use with this unique balance-training product. While toned bells with handles and an internal knocker are readily available, sturdy toned bells capable of being mounted on a platform—so as to be dingable by a ball moving on the same said platform—are harder to come by. It is harder still to find toned bells which besides being platform-mountable also have their sounding bell sufficiently low and exposed so as to be ringable by a ball moving on the same surface. Finally, a bell suitable for use with this unique balance training apparatus must also have sufficient sturdiness to withstand being repeatedly pulled forth from the platform—when grasped by a top-mounted strap and/or handle—even when the bell apparatus is connected to that same platform via an impermanent (but nevertheless quite tenacious) attachment means such as a “hook and loop” type attachment system. In short, for use with this product there is a need for sturdy, platform-mountable, ball-ringable bells of sufficient sturdiness to withstand being grabbed by a top-mounted strap and/or handle and repeatedly pulled forth from a base to which is is impermanently but quite securely attached.

### BRIEF SUMMARY OF THE INVENTION

To enable balance-related training to maximally challenge and encourage cognitive development as well as address balance-training boredom, there is a need for a balance training apparatus such as this which is uniquely both MULTISENSORY—involving sight, sound, and balance/proprioception stimulation—and INTERDISCIPLINARY—allowing for the intertwining and integrative training of diverse realms such as music, physical fitness/balance, geography, history, planning and coping skills, etc. In short, this device is unique in its ability to integrate PHYSICAL FITNESS/BALANCE training with a host of other areas of study and interest but particularly with MUSICAL expression, and thereby it can supremely function as a tool for motivating those with natural ability and interest in one of these realms to a greater participation and interest in the other/s. Through strategic use of this unique balance training apparatus a student's physical, musical, academic, and life skills can all be synergistically challenged and enhanced. The preferred embodiment of this invention (called THE MULTI-SENSORY AND INTERDISCIPLINARY BALANCE PLATFORM TRAINING APPARATUS or alternately/more simply, THE GIANT MUSICAL BALANCE BOARD or THE INTEGRATIVE BALANCE BOARD TRAINING APPARATUS) entails a balance board type apparatus with a substantively sized platform which has a raised rim on its surface at or near its periphery. This raised rim helps the user maintain a rolling ball within the perimeters of the platform's surface. There is a half-sphere sort of appendage attached to the platform's bottom side providing the instability enabling the multi-directional tilt of the platform. A person atop the platform adjusts his balance to change the tilt of the board and thereby cause a ball atop the platform to move at his direction. Thus—i.e. by making balancing adjustments—the user is enabled to direct the rolling of a ball to create music by ringing toned bells placed atop the platform as well as attempt other rolling-ball-based challenges limited only by the user's and/or his director's imagination. An integral attachment system allows for the adding, moving, removing, and exchanging of props whereby the variety of possible challenges is greatly expanded so as to surpass in this respect all other balance boards on the market today.

The bells—as well as other challenge-props used—are advantageously affixed to the platform so that they are both adequately secured and yet able to be quickly and easily added, repositioned, removed, or exchanged. This is accomplished in the preferred embodiment by means of a “hook and loop” attachment system. The hook side is affixed to the bottom of each bell (and to any other prop that one desires to secure to the top of the platform). The loop side is effected by means of a suitable carpet affixed to the platform. To address the need for bells of sufficient sturdiness and composition as to be usable herewith, this invention also describes a means for transforming bells more commonly found as “hand bells” (bells with handles and an internal knocker)—which as such are not suited for use in this application—into sturdy, platform-mountable bells that would be suitable for use with this unique balance and music, etc. training apparatus.

### BRIEF DESCRIPTION OF THE DRAWINGS

FIG. 1a-side view of assembled apparatus cut in half

(For expanded description and/or comments see paragraph 0076.)

FIG. 1b-detail of number 1 in FIG. 1a

(For expanded description and/or comments see paragraph 0077.)

FIG. 2a-topside view with carpet removed and with the cover plate over the center hole removed

(for expanded description and/or comments see paragraph 0078.)

FIG. 2b-detail of number 4 in FIG. 2a

(For expanded description and/or comments see paragraph 0079.)

FIG. 3a-underside view of apparatus with the hard plastic base of a BOSU® ball centrally attached to the bottom of the platform

(For expanded description and/or comments see paragraph 0080.)

FIG. 4a-topside view of apparatus with carpet attached

(For expanded description and/or comments see paragraph 0081.)

FIG. 4b—top side view of apparatus similar to FIG. 4a but showing one of many potential add-ons that could readily be attached thus greatly increasing this unique balance board's integrative potentialities. This particular add-on (number 24) is composed of a 12 white key span of a piano keyboard with black notes included.

(For expanded description and/or comments see paragraph 0082.)

FIG. 5a—top to bottom slice down the middle view of a BELL WITH WEBBED FABRIC HANDLE.

(For expanded description and/or comments see paragraph 0083.)

FIG. 5b—a drawing of the lower piece of felt referenced in number 8 of FIG. 5a

(For expanded description and/or comments see paragraph 0084.)

FIG. 5c—a drawing of the upper piece of felt referenced in number 8 of FIG. 5a

(For expanded description and/or comments see paragraph 0085.)

FIG. 5d-Same as FIG. 5a above minus the topmost two washers and the topmost nut the latter of which is replaced by (see number 10 in diagram) a smooth, rounded cap threaded internally to receive the top protruding shaft of the 3″×¼″ bolt.

(For expanded description and/or comments see paragraph 0086.)

FIG. 6a—Same view as FIG. 5a with a few additions explained below: 11 (“hook and loop” attachment means shown with one side connected to the orb below and the other side connected to the base of the cushioned cap above; 12 (cushioned cap to protect from injury anyone who might fall upon the top of the bell apparatus; 13 (“hook and loop” based attachment means shown with one side connected to the top of the cushioned cap below and the other side connected to the bottom of the label holder above); 14 (This is a clear-topped label holder into which can be inserted a vast assortment of informational labels for integrative/interdisciplinary purposes.

(For expanded description and/or comments see paragraph 0087.)

FIG. 6b—Topside view of numbers 12 and 14 in FIG. 6a and also showing the following: 17 (a label whereon the name “George Washington” has been written which label has then been inserted into the label holder so that it is visible through the label holder's clear top.)

(For expanded description and/or comments see paragraph 0088.)

FIG. 7a—Same as FIG. 6a with one addition explained below: 15 (a bell-color-concealment cap is attached via a “hook and loop” attachment means to the top of the cushioned cap and then the clear topped label holder—i.e. number 14—is shown attached to the top of this bell-color-concealment cap once again via a “hook and loop” attachment means.

(For expanded description and/or comments see paragraph 0089.)

FIG. 7b-Top view of FIG. 7a showing once again the label holder with inserted label seen earlier in FIG. 6b, but this time this label holder is attached to the top of the bell-color-concealment cap.

FIG. 8a-“USA” . . . BALL-GROOVE PROP

This diagram illustrates one of many possible fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped.
(For expanded description and/or comments see paragraph 0091.)

FIG. 8b-SCHOOL LETTER (“NSU) . . . BALL-GROOVE PROP

This diagram illustrates another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped.
(For expanded description and/or comments see paragraph 0092.)

FIG. 8c-MUSICAL SCALE . . . BALL-GROOVE PROP

This diagram illustrates yet another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped. (For expanded description and/or comments see paragraph 0093.)

FIG. 8d-SPIRAL . . . BALL-GROOVE PROP

This diagram illustrates yet another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped. For more insights applicable to this example as well see FIG. 8a above.

FIG. 8e-MEANDERING SQUIGGLE . . . BALL-GROOVE PROP

Yet another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped. For more insights applicable to this example also see FIG. 8a above.

FIG. 8f-FIGURE EIGHT+SWIGGLE & SWOOP . . . BALL-GROOVE PROP (a.k.a. THE SMILING GOGGLE MAN)

Yet another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped.
(For expanded description and/or comments see paragraph 0096.)

FIG. 8g-FRONT-TO-BACK+LEFT BANANA & RIGHT BANANA . . . BALL-GROOVE PROP

Yet another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped. (For expanded description and/or comments see paragraph 0097.)

FIG. 8h-MAZE . . . BALL-GROOVE PROP

Yet another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped.
(For expanded description and/or comments see paragraph 0098.)

### DETAILED DESCRIPTION AND BEST MODE OF IMPLEMENTATION

The preferred embodiment of this integrative balance trainer is a balance board type of apparatus with a top platform of a circular shape and substantive diameter and made from wood of an adequate thickness; AND with polyethylene tubing on the top side all around near the periphery forming a raised rim of adaquate height which rim is secured to the plywood by carriage bolts; AND with a carpet attached to the plywood on the top surface within the circumference of the rim which carpet is of such a composition as will enable it to function as the “loop” side of a “hook and loop” type of attachment system; AND with a BOSU® ball (heavy duty “Professional” model) balance device attached centrally to the underside of the plywood platform serving to raise the platform adaquately above the surface of the ground and providing the instability necessary to enable the platform to tilt in all directions as directed by the user's balancing adjustments; AND with toned bells so fashioned as to be mountable on a surface using a “hook and loop” attachment system.

Note that the hook side of the “hook and loop” system is affixed to the underside of each bell and likewise—if deemed necessary—to the underside of any other prop used. The bells revamped for use in this capacity were from a Kidsplay® 8 Note Diatonic Handbell set. They represent the eight notes from C to the next higher C inclusive. [Note: These notes/tones would correspond to all the white keys on a piano keyboard. Bells representing all of the “black notes” are also available thus enabling any song to be played in any key.] Each of the seven different notes has a different color with red being repeated twice—the first note/C being red in color and the last note/C (one octave higher than the first C) once again being the same red color.

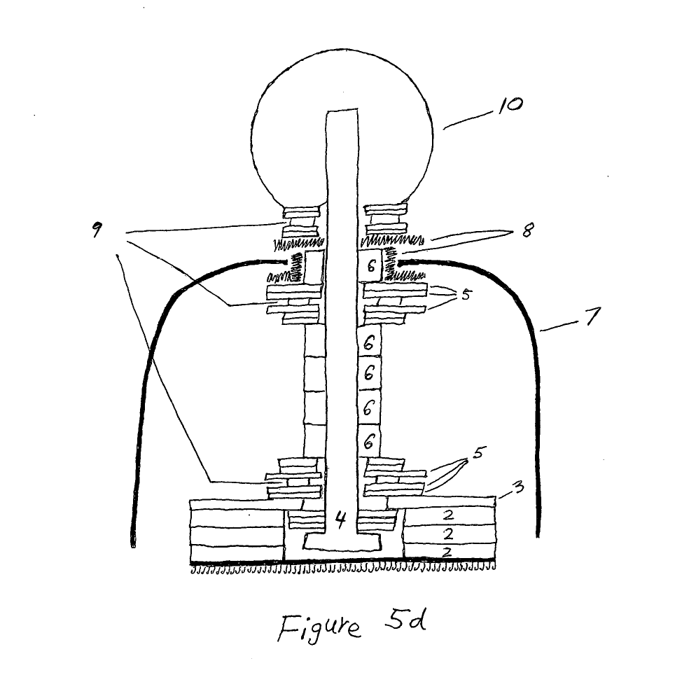

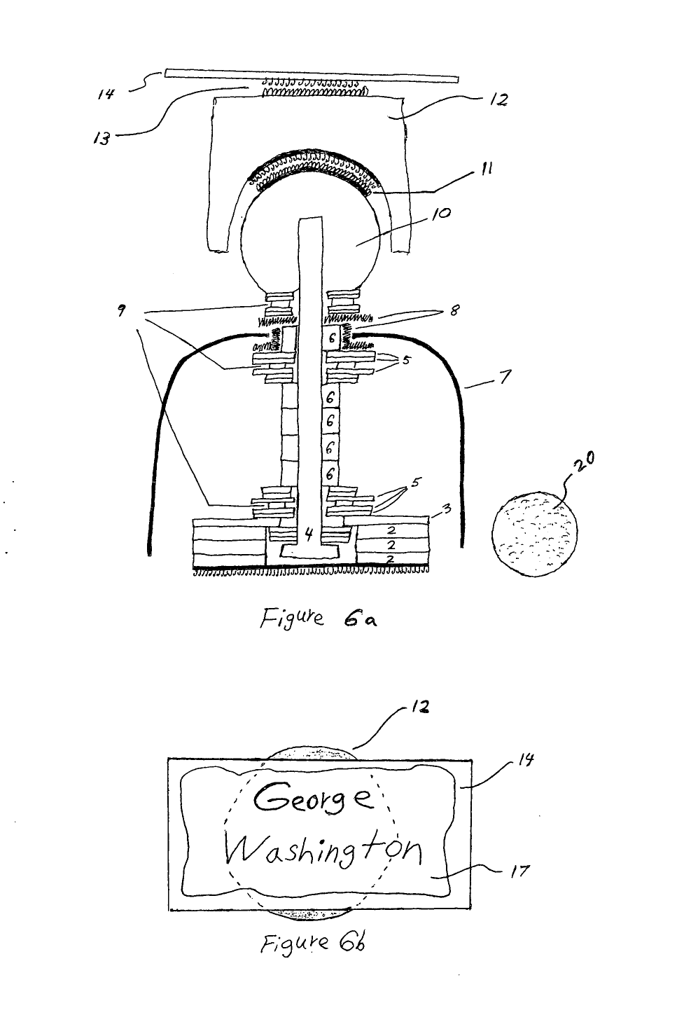

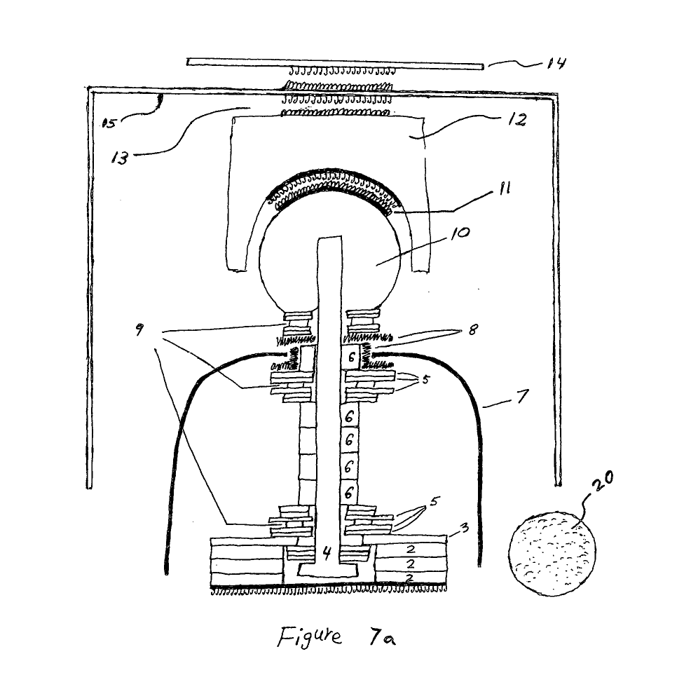

Following are all of the eight notes and their corresponding colors: C (red); D (orange); E (yellow); F (green); G (light blue); A (dark blue); B (purple); C—next octave up from the first C (red). The handles were removed and the bell portion was mounted otherwise so that it would be usable in this capacity (as seen in FIG. 5a). The whole metalic bell assembly (as shown in FIG. 5a) stands about 4.5″ tall, and including the webbed loop is about 4.5″ tall. The bell/sounding portion itself is 3″ wide and 1.75″ tall and is raised ½″ off the ground by the stand which thus suspends it.

Notwithstanding the above descriptive details, however,—or any descriptions which follow—it should be noted that the details given herein are to clarify the fundamental idea/ideas and should not be construed as limiting the natural scope and application of the fundamental idea/ideas. For example, the board could be somewhat smaller, or it could be somewhat larger, or it could be oval shaped rather than circular, etc., etc. Likewise (for example) instead of a BOSU® ball, another appendage similarly flexible or else more rigid in nature—and having a similar half-ball or even a different shape—could be affixed to the underside of the platform. [NOTE: The only requirement is that it—like the BOSU® ball used with the preferred embodiment—be of a sufficient depth to accommodate the diameter of the platform—i.e. it needs to lift the platform high enough so that the platform can tilt sufficiently without its edges too readily touching the ground.]

As such, this apparatus—which may subsequently be referred to as “The Giant Musical Balance Board”—is a unique BALANCE training and challenging tool capable of enabling the integrative and simultaneous training of both BALANCE and MUSIC. With this unique balance tool users are uniquely enabled to combine and integrate the physical fitness and sport benefiting aspects of BALANCE with the creative and expressive aspects of MUSIC. You in effect create MUSIC by means of BALANCE! Although there are many possible integrative connections that could be made using this versatile product, MUSIC and BALANCE would seem to be the primary integrative pairing made possible by this unique product. A number of examples will follow giving a sampling of some of the many ways that the Giant Musical Balance Board could be utilized to integrate MUSIC with BALANCE. Examples will also be given showing other integrative uses for this product as well. The vast integrative connections that can be forged through the use of this product are limited only by the imagination.

This integrative—i.e. BALANCE+MUSIC—approach is very advantageous. For—on the one hand—The Giant Musical Balance Board advantageously serves to fend off BALANCE training boredom and disinterest by enabling the integration of MUSIC into the balance-training environment. Adding this MUSICAL dimension helps to distract the mind from the PHYSICAL rigors and tedium that tends to hinder BALANCE training and advancement. Conversely, the Giant Musical Balance Board also serves to fend off MUSIC training boredom and disinterest by distracting the mind from the MENTAL rigors and tedium that tends to hinder MUSIC learning and advancement (especially at the introductory stage). Some examples will follow that should make it clear how this unique tool can be utilized to link/integrate FAR MORE THAN JUST MUSIC with BALANCE. Indeed, MANY SUBJECT AREAS can be integrated through the strategic use of this unique balance tool.

From the BALANCE/fitness improvement standpoint, this tedium-thwarting benefit is accomplished by enabling the BALANCER to focus on and accomplish something not normally associated with BALANCE—namely, producing TONES, TONE sequences, or even SONGS—which are in fact directly caused by his dexterous and precise BALANCING adjustments. Thus by uniquely integrating the stimulation of MUSIC expression and creation with the otherwise less interesting task of BALANCE board training, both MUSIC and BALANCE ability can be advanced beyond what each could effect standing alone. Moreover, in that many changes can be introduced involving 1.) the tone, tone sequence, or song, AS WELL AS 2.) the speed of the same, AS WELL AS 3.) the position of each tone producing device (bell, electronic tone tripper, etc.), etc., etc., the challenge can be vastly varied allowing maximum integration of and challenge to both the mental/MUSICAL and physical/BALANCE faculties.

As such this BALANCE and MUSIC integrating apparatus is an interdisciplinary bridging device linking the more physical-fitness-and-sports-oriented BALANCE training WITH the more cognitive-and-creative-oriented aspects of MUSICAL expression. In short, it is a device whereby the user can actually express himself MUSICALLY by means of precise changes in relation to the physical BALANCING of his body! Hence this BALANCE board does in fact uniquely enable the simultaneous and causal integration of physical BALANCE and MUSICAL expression with all the benefits attendant upon such a unique and interesting combination of these disparate and hitherto uncombined training realms. Through use of this discipline-bridging device, MUSICALITY and BALANCEABILITY can be both integratively encouraged and strengthened each by the other. Thus through INTEGRATION—where two (or more) disparate fields of interest are brought together to interact with and encourage the other—the overall advance to the user can prove “far greater than the sum of the parts”. The Giant Musical Balance Board is a tool that enables the user to tap into this powerful phenomenon.

It should be noted that (for the vast majority of users) it is very difficult and it will take much practice to develop the proficiency required to produce music/songs with The Giant Musical Balance Board. However, it is very important to note that even at the beginning stages where the user lacks the skill necessary to actually produce anything resembling “music”, simply adding the element of“sound” makes balance training more interesting. For example, dinging one bell may not be “music”, but it is far better than no sound at all/silence. Simply having the element of “sound” increases interest/incentive/participation because motivation increases and a sense of accomplishment is provided when one can audibly hear that the task has been accomplished. “Ding!” says, “You did it!” far better than silence does.

Here is an example of an early stage activity that can be done with this integrative BALANCE training apparatus. [Notice that even though this activity is in the “pre-music making” category, it still utilizes the tone-making potential of the bells to good measure.] One of the easiest tasks for beginners to accomplish is simply causing the ball to travel around and around the outer rim—clockwise . . . then counterclockwise. A bell/s can be placed near enough to the rim to be sounded by the passing ball yet far enough away so as not to stop the ball's movement. In this way the bells can be used at a very early stage to add audio-based interest and encouragement to the balance-training workout.

Here is yet another “pre-music making”—yet tone utilizing—example: The two red/C/“Do” bells could be placed on opposite sides of the platform. One or more of the other bells could then be placed somewhere between representing “bombs” to be avoided. The goal would be to successfully ding both “Do” bells while avoiding the “minefield” (i.e. while not dinging any of the other tones/bells.

Here is a little more difficult “sort of music” example that a user can eventually attempt as his skills increase: The first three bells of the scale are placed on the platform and the user attempts to ring all three in sequence . . . then four . . . then five . . . with the challenge incrementally increased over time until he is able to ring all 8 bells in proper sequence. To increase the (imaginary of course) stakes and thereby increase the excitement level (for imaginative young users) this could be presented as a variation on “minefield” by referencing any tone played out of sequence as a “mine”.

Eventually the user can actually progress to the point where he can begin to “ding” out actual music. Actual songs. Simple songs at first, like “Twinkle, Twinkle, Little Star”. And then incrementally progressing to longer and more difficult songs.

And at any time during any of the above attempts, a director need only rearrange the bells involved to force the user to reassess the new situation and forge a new “plan of attack” on the fly. This, of course, will help to develop the user's ADAPTATION skills.

Here is an example of the sort of high level challenges and advanced skills that can be brought to bear/developed via the use of this product. Scenario: The bells are scattered on the platform by another while the user is blindfolded. While still blindfolded the user is told the song he must attempt to produce. The user's blindfold is removed and he begins. [It is a contest and he will be compared to others on the basis of such things as accuracy, speed of completion, and maintaining a consistent tempo of “play” throughout.] Of course, there is HUGE challenge potential here. Perhaps the most difficult challenge will be quickly assessing the situation in order to calculate the speed at which he should start the song in order to be able to maintain a consistent speed in light of the distance between the various bells he will be needing to access for this particular song. Clearly the challenge level involved here even for a simple song would be quite immense, and would be astronomical for a more difficult piece. This should serve to illustrate the exceedingly high level at which this product can be used—integratively with BALANCE—to challenge a user MUSICALLY:

In light of these—and other examples that have and/or will be given—it should become clear that this balance product owns a range of variability that renders it insurpassing in its ability to challenge and interest users.

Also, it should be noted that the large surface in combination with the “hook and loop” prop-attachment system provides a decided advantage in that it allows the balance challenge to be quickly adjusted. For example, a trainer can quickly add a sand bag or ankle weight anywhere on the platform's surface and the user must immediately adjust his balance to compensate—and not just his balance, he must also immediately adjust his “plan of attack” to circumvent this newly introduced obstacle in the ball's way making it more difficult to ring the bells. Thus—through the use of this unique balance tool—not just the user's balance but also other mental skills such as the skill of ADAPTATION can be trained and challenged to improve.

Another option is to attach carpet—and/or magnetizable metal sheeting (c.f. note regarding use by the blind)—not just to the top surface of the platform but to the underside as well. Doing so would make it possible to attach moveable/removable weights at varying points beneath the platform which would function as balance-challenging props. Such an ability to add offsetting weight/s would increase the variability and heighten the balance challenge to the user. And being able to add weights to the underside of the platform would allow you to thus increase the balance challenge to the user (requiring him to adaptively compensate) WITHOUT CLUTTERING UP THE SURFACE. [Note that another option for attachment of props and/or weights is a tacky/sticky based system (such as would be possible via the use of Dysem® or a similar material), or even a suction-based attachment system; but the first of these would probably not be adequate for attaching weights to the underside of the platform. It would also be possible to integrate BOTH a “hook and loop” AND a magnet based attachment means into the same balance apparatus on either the top side or on the bottom side or on both sides: a magnetizeable metallic sheet can be attached to the board beneath the carpet enabling the INTEGRATIVE BALANCE BOARD TRAINING APPARATUS to accommodate BOTH magnet secured AND “hook and loop” secured props and/or weights. It should be noted that even if a magnetic means is chosen for attaching props to the topside, having carpet on top of the magnetizable sheet metal will result in a quieter/calmer sound effect for it will deaden the sound of the ball careening about. Of course, in such a case the carpet coming between will lessen the magnetic attraction between the magnet-bearing prop or weight and the magnetizable sheet metal on the other side of the carpet, and therefore, a stronger magnet may be required to compensate for this effect.] Having the ability to attach weights beneath the platform could also be advantageous when using the GIANT MUSICAL BALANCE BOARD in a joint/cooperative/tandem balancing activity (i.e. with more than one balancer atop the apparatus's platform). This ability to add weights beneath would be especially advantageous in this connection when such balancers are of unequal weight. Weights could thus be attached to the underside of the board beneath the lighter balancer/s creating a weight-equalizing effect without cluttering up the surface.

Here are some notes regarding the rim. In the present working prototype and on the diagrams the rim is made using 1” polyethylene tubing (NIBCO® PEX; Model Number: PX60228). It is connected using six carriage bolts which extend straight down through the plywood platform. For strength considerations—i.e. test the carriage bolts be too close to the edge of the plywood and break through—the rim is fixed slightly in from the periphery. Seen from the underside, the center of each carriage bolt head is about ⅞″ from the edge. The head side is down/faces the underside of the platform because the head side protrudes less than the nut side and it is desirable to prevent this bolt from contacting the ground. Also, the head side of a carriage bolt needs to bite into something and on this side it can bite into the wood of the plywood. However, because the nut side protrudes more in this case, there is a danger of a user being injured if he/she were to fall on one of the six places where the bolts protrude above the rim. It may be desirable to cover these protrusions with a smooth rounded cap. Another possibility—if cost is not prohibitive—is to find or extrude a rim made of rubber and/or plastic which could be bent around the plywood edge and glued and/or nailed in place. Such a rim would be softer than the present embodiment and would avoid the protruding, hard, and sharp bolt ends. Also, such a rim would cover the plywood's outer edge so that when this edge touches the ground during use (which often happens) the bang of wood hitting ground would be avoided.

For safety, the bolt ends (mentioned in the paragraph above) attaching the raised rim to the plywood can be topped with a smooth cap, with a protective cushioned cap, or a cushioned top can be placed all around the top of this raised rim. Also for added safety the outer edge of the plywood can be cut with a rounded contour and/or a cushioned bumper can be attached to this outer edge to protect the toes, fingers, etc. of any onlookers who may venture too close when this edge makes contact with the ground as can happen often especially with less experienced users.

There are six groups that can most obviously benefit directly—with attendant positive repercussions for society at large—through the use of this integrative BALANCE and MUSIC, etc. Training tool:

1. FITNESS AND SPORTS ENTHUSIASTS who already have interest and ability in FITNESS/SPORTS, can thus be motivated towards an increased interest and ability in MUSIC with the attendant cognitive and social, etc. benefits thereof

2. MUSIC ENTHUSIASTS who already have interest and ability in MUSIC, can thus be motivated towards an increased interest and participation in physical FITNESS with the attendant health and social, etc. benefits thereof.

3. “GAMERS” who are not so much interested in either MUSIC or SPORTS/FITNESS per se, but who are excited by games and challenges—especially of a more individualized nature—will be nudged by the use of this integrative tool towards an increased interest, participation, and advancement in both FITNESS and MUSIC expression and learning with the attendant health, cognitive, and social, etc. benefits thereof.

4. Using this integrative tool EDUCATORS will be able to leverage interest in FITNESS/SPORTS to motivate MUSIC learning and participation. Conversely, EDUCATORS will have an integrative tool to leverage interest in MUSIC to engender interest, participation, and advancement not only in PHYSICAL activity but also more SCIENCE related fields such as KINESIOLOGY and PHYSICAL THERAPY. This device uniquely enables the integration of two realms not otherwise connected so directly, namely, BALANCE training (hitherto an endeavor pretty much limited to the realm of physical fitness/sports) and MUSIC creation (hitherto an endeavor more limited to the artistic/emotional expression realms). It seems reasonable to suggest that the attendant neurological interconnections which form as a result of such interdisciplinary interplay will positively impact net educational outcomes. Thus through integration—where two disparate fields of interest are brought together to provoke greater interest/participation in the other—the overall profit to the STUDENT will prove to be “far greater than the sum of the parts”. This being true, The Giant Musical Balance Board is a key tool whereby EDUCATORS can strategically leverage the power of integration to reap the educational benefits of this powerful phenomenon. Moreover, the ability of this tool to integrate a physical activity [BALANCE] with more academic material will especially help to more effectively interest and involve those with ADD and ADHD (as well as others with learning challenges) in the educational process.

5. HEALTH CARE PROVIDERS who serve those with mental health issues—i.e. mental health workers, and also physical therapists involved with stroke rehabilitation, etc.—can use this tool to incrementally challenge/improve the sequential planning, coping, and adapting skills of their patients. By simply (for example) changing the location of one or more of the bells on the surface, the user's ability to think quickly/change plans/adapt can be challenged and thereby improved. Because the “hook and loop” system used with this balance board uniquely enables the quick and easy alteration of many variables, it can serve as a premier tool to help improve the mental health of those with coping/adaptation, etc. issues. It should be noted that the ability of this tool to challenge and thus improve coping/adapting skills would be beneficial to all the other groups mentioned here as well—i.e. athletes, the elderly, etc.

6. The ELDERLY will also eventually be benefited because good health practices developed at an early age will have positive long-term effects. Moreover,—and more impactful in relation to this unique BALANCE board's benefit potential—reason would suggest that BALANCE skills developed at an early age will result in fewer falls in older age with huge attendant benefits to the health, well-being, and quality of life of the elderly as well as providing a huge benefit to society as a whole resulting from decreased health care costs. Also, music interest piqued at a young age will result in an increased ability to enjoy and appreciate music over the course of a lifetime.

The following is a summary of some of the various senses and/or cognitive realms that would seem to be integratively and simultaneously challenged by this unique tool:
The AUDIO/MUSICAL cerebral realm/s are involved via the differing toned bells and the ability to vary the ringing of the same in relation to sequence, speed, and rhythm.
The cognitive realm related to LINKING is involved via the association of each bell tone with a different color.
The VISUAL related cognitive realm is involved via the ability to place differing colored bells at various places—front, back, and to the sides—in relation to the orientation of the user. Through this means peripheral vision, etc. is challenged/strengthened. Also, the user must continuously track visually the movements of the ball on the platform's surface.
The cerebral realm/s involved with PLANNING and COPING/ADAPTING can be challenged/strengthened via the ability to easily and quickly change the location of each prop (bell, etc.) on the board's surface as well as the tone, tone sequence, or song requested.
The SPACIAL and MEMORY cognitive realms are involved in the sorts of challenges wherein users have to remember which bell in which location produces which tone.
And tying all of the above together, the instability produced by the rounded half-ball beneath brings the COCHLEAR-connected cerebral realms related to PROPRIOCEPTION and BALANCE into play and involves them integratively with all of the others, for it is by BALANCE itself that this unique tool links and involves all of the above simultaneously

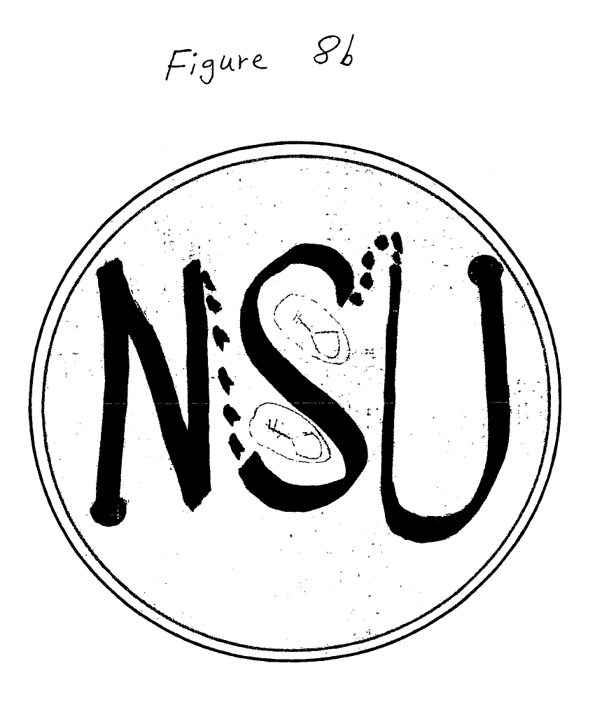

One of the primary challenges made possible by this unique device is the playing of songs by means of balance—i.e. the user adjusts his balance to direct the movement of a ball on the platform's surface to ding differently toned bells and thereby produce songs. Take, for example, the song “Twinkle, Twinkle Little Star”. Producing this “simple” song would require the use of 6 bells—in fact, the 6 bells that play the first 6 notes in any key. Therefore, producing this song in the key of C would require the six bells that produce the first 6 tones/notes in the key of C, namely, the C,D,E,F,G, and A toned bells. A facilitator has many options as far as labeling or not labeling these bells depending on his objective/s. He may choose to attach note/tone identification labels to the top of each bell in order to help his users become better acquainted with this particular knowledge as he/she goes about the task of producing the song. Or—if using colored bells—he may choose to forego labels and either tell the users beforehand what colors to ding and the order in which to ding them to produce this song, or challenge them on a higher level by telling them to figure out the color sequence on their own. Or—to heighten the difficulty yet further—he may even deem it beneficial to use bells of a uniform appearance (i.e. neither colored nor labeled so that the tone of each bell is not visually identifiable) and randomly arranged AND STILL forego labels so that users must figure out the song by trial-and-error, and then remember the location of each bell tone and the sequence in which they must be accessed to produce the song. This latter form of challenge would seem to amount to a spacial-tonal-memory challenge—a sort of tonal equivalent of the well-known, picture-based memory game called “Memory” [Note: The latter challenge could be effected EITHER by using bells with a similar appearance (as stated above) OR by using the bell-color-concealment caps as seen in FIGS. 7a-b minus the label in the label holder.]

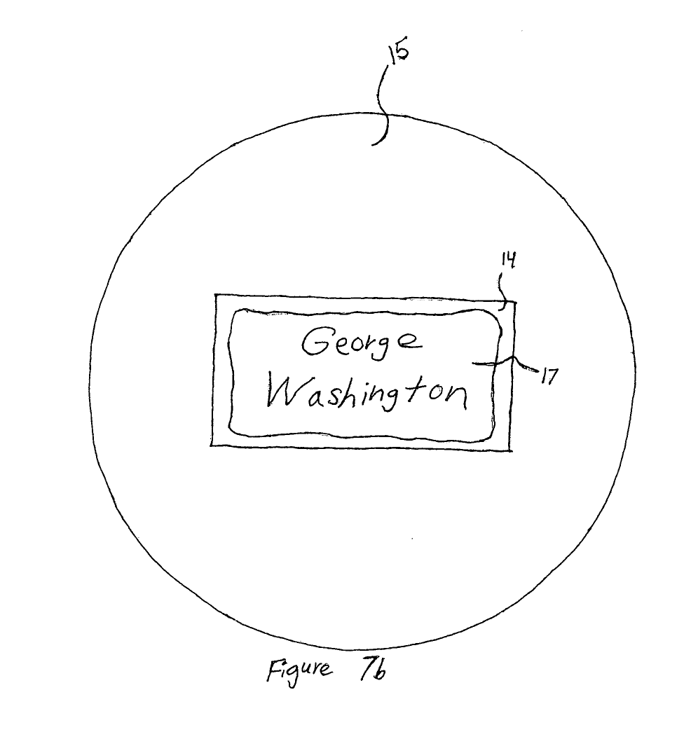

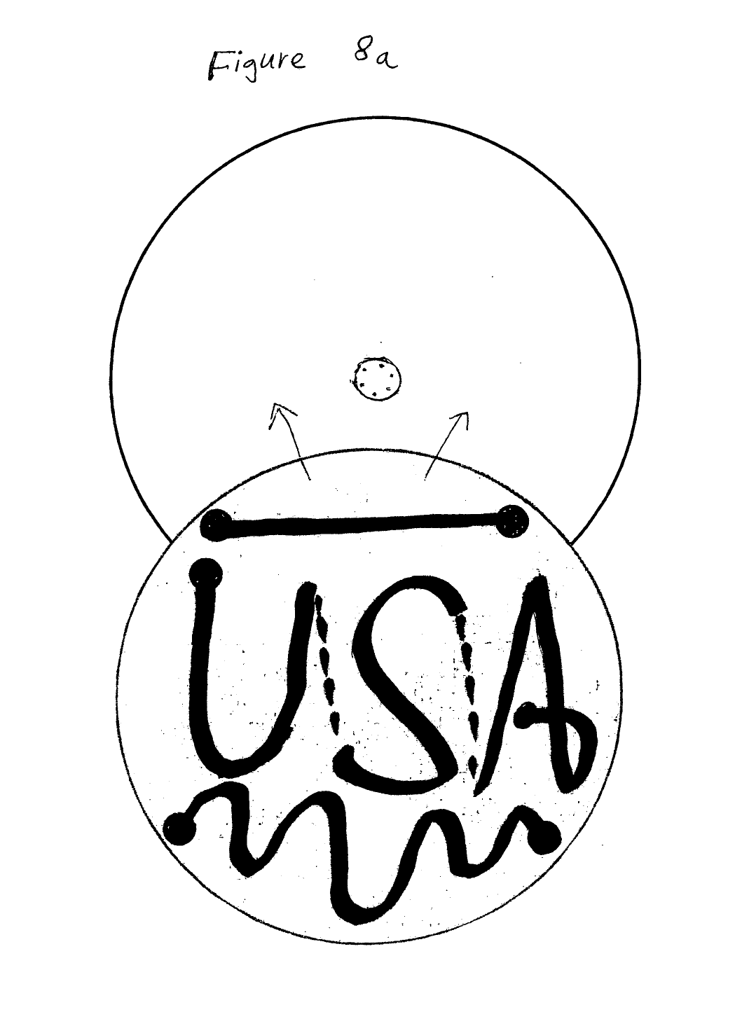

The degree to which this balance device can be used integratively—i.e. to connect the more physical aspect of BALANCE training with other more ACADEMIC or ARTISTIC, etc. subject matter—is very extensive and is limited only by the imaginations of the users. There follows one example—in three stages of difficulty—whereby this integrative tool could be utilized to integratively bridge a three-way BALANCE-to-HISTORY-to-MUSIC connection:
A Lower Level Integrative Challenge—comparatively speaking (i.e. of the three challenges given here this first one is the least difficult): Labels containing the names or pictures of the first 8 presidents of the United States could be taped or otherwise affixed (see FIGS. 6a and 6b) to the top of each bell—i.e. so that the name “George Washington” would be visible atop the first/red/“Do” bell, and John Adams's picture would be visible atop the second/orange/“Re” bell, and Thomas Jefferson's picture would be visible atop the third/yellow/“Mi” bell, etc., etc. The user will come to learn the names of the presidents in order as he directs the ball (by his balancing adjustments) to ding the colors/tones in sequence. Perhaps it could be specified that he has successfully met the challenge if he dings all the scale's notes in sequence while saying the president's name affixed to each bell as he rings it. Of course, to do the above the user would have to know the bell color order corresponding to the order in which the notes of the scale are played—i.e. he would have to know that the notes of the scale C,D,E,F,G,A,B,C correspond to the colors red, orange, yellow, green, light blue, dark blue, purple, red. But even a user who does not start out with a working knowledge of the (somewhat artificial and arbitrary perhaps) connection between bell color and scale order, if he is audibly familiar with the 8 tone sequence of an octave, he can be challenged to figure out for himself—i.e. teach himself!—the proper order of the first 8 presidents by trial and error as he figures out the order in which he needs to play the bells to produce the well-known, key scale tone sequence. But users who know the bell color order which corresponds to a key scale's tone sequence can simply be instructed to work on dinging the bell colors in the proper order while saying the name atop each bell as he dings it. In this way he can integratively learn HISTORY (i.e. the names of the first 8 U.S. presidents in proper order) while he simultaneously improves his BALANCE skills and becomes more MUSICally familiar with the sound pattern of a scale.
A Higher Level Integrative Challenge (comparatively speaking): [Note: Both this and the next higher-challenge option would require that each label (containing a president's name) which is taped to the top of each bell be LARGE ENOUGH SO THAT THE BALANCER CAN NOT SEE THE COLOR OF THE BELL BENEATH. Or the bell-color-concealment caps shown in FIGS. 7a and 7b could be used each of which incorporates a label holder for displaying such a name.] This challenge is a bit harder in that—because the bell colors are concealed—the balancer would need to already know in order the first 8 presidents to successfully sound all eight tones in their proper sequence from the start. Of course, as in the previous example, here also a user could teach himself the proper presidential order by trial-and-error if he is familiar with the well-known 8-tone sequence of an octave. In any event, this challenge is a bit harder because the user must EITHER know the proper order of the president's beforehand OR he must rely on his scale-tone-recognition ability alone to figure it out for himself because the “crutch” of bell coloring has been removed. [Note: Of coarse, if noncolored bells of a more uniform appearance were used, they would only need to be labeled but would not have to be concealed to facilitate the above challenge.]
A Yet Higher Level Integrative Challenge (comparatively speaking): [Note: Once again the bell colors would be concealed—as in the example immediately above—by taping (or otherwise affixing) a label large enough to adequately conceal the bell from the user. Of coarse, once again, using the bell-color-concealment caps shown in FIGS. 7a and 7b could conceal the bell colors.] For this challenge, a facilitator would choose a song and NOT TELL the students the name of the song. He would then take the first 8 (or however many he chooses) notes of that song and attach the first president's label (i.e. “George Washington”) to the bell needed to sound the First note, and then attach the second president's label (i.e. John Adams) to the top of the bell needed to sound the Second note, etc., etc. The challenge thus would be threefold: 1.) first learn the HISTORY of the first 8 U.S. presidents in proper order, AND 2.) develop the BALANCE skills needed to ding each corresponding bell in proper order, AND 3.) have the musical skill and knowledge needed to successfully discern the name of the song. [Note: In this example the user would need to be able to discern the song without having any timing cues. A facilitator could ameliorate this “drawback” by simply disclosing the timing of each note (i.e. 1^{st} President/1^{st} tone: whole note; 2^{nd} President/2^{nd} tone: quarter note, etc.) However, keeping it a bit more difficult and abstract may advantageously add to the challenge and benefit of the activity.] If it were a contest, the user who figures out the song the fastest wins. For example, the first 8 notes of “The Star Spangled Banner”—corresponding to the words/partial words “O-Oh-say-can-you-see-by-the”—are G-E-C-E-G-C-E-D. So for this song the facilitator would affix the following labels to the following corresponding bells:

```
1^{st} President—“George Washington” label—G/light blue bell
2^{nd} President—“John Adams” label—E/yellow bell
3^{rd} President—“Thomas Jefferson” label—C/red bell
4^{th} President—“James Madison” label—E/yellow (i.e. James Madison's label would have
                                    to be placed on a second E bell because E
                                    has been used already by “John Adams”
                                    previously.)
5^{th} President—“James Monroe” label—G/light blue (i.e. a second G bell would have to
                                    be used because G was used for
                                    “GeorgeWashington” previously)
6^{th} President—“John Quincy Adams” label—C/red (i.e. a second C bell because C was used for
                                    “Thomas Jefferson” previously)
7^{th} President—“Andrew Jackson” label—E/yellow (i.e. a third E bell because E has been
                                    used twice already)
8^{th} President—“Martin Van Buren” label—D/orange
```

[Notes: As can be seen, to facilitate the above integrative challenge—at least for this particular song—would require the use of several sets of bells because a number of tones/notes are sounded more than once. Also, for the above challenge the bell color would not have to be concealed in cases where the user is unaware of the tone-color connection or is less musically attuned. However, if the bell colors are not concealed it would be possible for a more musically inclined or “resourceful” user to learn how to figure out the tune based on bell color. Thus if the bell colors are not concealed, more musically attuned users could undesirably skip—and miss out on the benefit of—the BALANCE component of this integrative activity. But to do so (in the above example), such a musically gifted user would still have to know the first 8 U.S. presidents in proper order.]

To better understand the versatility of this product, consider that within each of the above challenges many variables can be tweaked to strategically lessen or increase the difficulty. For example, a facilitator can strategically arrange the bells MORE SEQUENTIALLY—i.e. closer to one another based on the order in which they will need to be played—and MORE IN FRONT of the user (to lessen the difficulty), OR he can place the the bells MORE HAPHAZARDLY and ALL OVER the surface of the platform (to increase the difficulty).

The three-tiered example above should help to illustrate how this integrative tool can be utilized to integratively link the more physical fitness related aspect of BALANCE with the more artistic realm of MUSIC and with other more academic realms of study and interest such as GEOGRAPHY, HISTORY, etc. And, actually, in the above example itself three things are integrated simultaneously—1.) BALANCE . . . 2.) MUSIC . . . and . . . 3.) HISTORY!

FIGS. 6a-7b show a “hook and loop” based system both for attaching labels (such as were required for all three of the above challenges) as well as for attaching bell-color-concealment caps (such as were utilized in the second and third of the above challenges). By making it quick and easy to attach labels and/or conceal bell color, these tools enable educators, directors and other facilitators to maximize the integrative range and challenge potential of this unique, integrative balance tool.

Perhaps there is much that we do not yet know about the learning power and benefits of MULTI-SENSORY STIMULATION and INTERDISCIPLINARY INTEGRATION. No doubt, much about the brain and/or the mind is still a mystery. Perhaps then also this unique product benefits somewhat . . . mysteriously . . . by linking balance with sound . . . the motion and kinesthetic “sense” to the audio and musical “sense” . . . the more PHYSICAL realm to the more EMOTIONAL realm. By waiting till we know more, we miss out on the benefits that we could harness now. Why wait? We know enough. STIMULATE! INTEGRATE!

A very intriguing and interesting possibility is the use of this SOUND and BALANCE integrating apparatus by the BLIND. It is very conceivable that—if the ball's rolling were made more audible by (for example) removal of the rug or otherwise—a BLIND person could participate to an extensive and rewarding degree: Of course, in such a case—i.e. if the carpet were removed—a system other than “hook and loop” would have to be used to adhere the sound-emitting props to the balance board's surface. One example of such an iteration would be to use MAGNETIC PROPERTIES instead wherein (for example) the balance board's surface could be covered with a magnetizable layer of sheet metal and the props could have magnet/s affixed to their undersides. Also, a sticky/tacky based attachment system could be utilize by attaching a material such as Dysem® to the underside of each prop to help keep them in place. Or a suction based attachment system could be utilized. Also, it is conceivable that a sound or vibration-based system could be integrated to enable a blind user to continuously and precisely orient himself to the position of the ball on the balance board's surface in relation to the position of the bells. For example, a clicking noise could be used that would get louder or faster as the ball got closer to a bell. Perhaps the clicking noise could change tones as well so as to have the same tone as the bell it is approaching.

The platform of the preferred embodiment is large enough where it could be used to stage many interesting potential “add-ons” or “props”. One example of such would be an appropriately sized maze complex or a labyrinth with holes to be avoided. Also boards with differing shaped grooves for the ball to roll in could be placed on the platform's surface to elicit from the user the varying movements that would be required to cause the ball to “follow” a spiral or a squiggly or a more meandering “trail” or a path, or any of various letters, etc. These grooved boards could cover the entire top surface of the balance board so as to enable a balancer to be challenged from all sides, or they could be smaller so as to be positioned only ahead of the user who is stand-balancing at the center of the board. These could be made of wood or plastic or a plastic-paper composite, for example, and then have a shaped groove for a ball to “trail in” routed deep enough into the surface of the board to adequately retain a given size of ball. Of course, the movements of the ball through the maze or along each grooved “trail”, etc. would be directed by the user's balancings either as he stands atop or as he manipulates the board's tilt manually from beside. This product also enables the motivation of sound to be integrated into many of the above by placing a bell at both or either end of all of the above “trails” to provide an audible confirmation and encouragement that a notable milestone has been reached/the task has been accomplished. Or—in the example of a labyrinth—the entire scale of tones could be placed sequentially at evenly spaced intervals along the “trail” to enable the user to audibly and color-visually (if colored bells are used) mark each milestone of accomplishment and “compare” notes:

Conrow: I've gotten to Green and am working on Aqua, how about you Frank?”
Frank: “Me too Conrow, I've dung the ‘Fa’ and am working on ‘So’, and I plan to finish dinging the last ‘Do’ before you do Conrow.”
Conrow: “You're on! And the loser buys the winner a pop.”

### Frank: “Deal!”

No doubt such a “Giant's Labyrinth” would prove very popular to young and old alike.
Note particularly the advantages afforded by the possibility of a labyrinth thus mounted. The simple-sourced tilt ability enabled by the half-ball beneath The Giant Musical Balance Board would allow a user to direct the ball along the labyrinth's “trail” WITHOUT THERE NEEDING TO BE THE TWO KNOBS normally used with balled labyrinths. By thus integrating a labyrinth onto the surface of the Integrative Balance Board Training Apparatus the means of directing the ball is simplified from the normal means used with such contraptions and enables the feasibility of a human-powered labyrinth on a MUCH LARGER SCALE.

No option mentioned as a “prop”—in the sense of an auxiliary or add-on embellishment to the basic balance board with platform—need be such. All such “props” could instead be integrated permanently into any unit sold or used. In some cases this may be preferable. For example, a large labyrinth—i.e. a “trail” for a ball to follow along while avoiding the holes—may be best attached in a permanently integrated manner. But overall it would seem best to preserve the vast variability and variety that is made possible by incorporating add-ons to the basic platform which are of a moveable/removable nature.

A very important point to keep in mind [from a marketing standpoint especially] is the ability of the Giant Musical Balance Board—and any “prop” mounted thereon—to be manipulated by hand as the user sits or kneels beside it (if the balance board is on the floor) or as the user stands beside it (if the balance board is raised up as on a table) rather than by stand-balancing on its surface. This possibility greatly expands the marketable range of this product in that it enables this product to be used in contexts where—due to safety concerns or user handicaps—stand-balancing is untenable, as for example in a nursing homes where safety considerations mitigate against stand-balancing atop the surface. Also this possibility enables the safe use of this product at times when less supervision is available. A teacher, for example, could instruct his students that they must ask and he must be present for them to stand atop the board, but that they are allowed to use it in a hand-manipulated fashion at other times. Through this possibility, the time range in which this product can be safely used to integrate BALANCE with MUSIC and other subject matter can be greatly expanded to the benefit of the students. Also the possibility of hand-manipulating the board's tilt, can enable students to participate immediately in integrative and recreational challenges which would otherwise require much time and practice to effect via stand-balancing skills.

The substantive size of the preferred embodiment even allows for the possibility of a cooperative/tandem/team approach to balancing wherein two—or perhaps even more —individuals standing together atop the platform could cooperatively balance to direct the movement of the ball around the rim's perimeter or wherever desired to tackle this challenge or that. As was mentioned earlier, the ability to add weight/s beneath the board's surface could prove advantageous in this connection by providing a means to even out the weights of joint participants who are of dissimilar weights without having to clutter up the surface with such weight-evening-out accoutrements.

The bells must be in a form compatible for use with The Giant Musical Wobble Board. The sounding portion of the bells used to make the bell prototypes for this product came from a “KIDS PLAY® 8 NOTE HANDBELL SET” (RB 108) sold by Rhythm Band Instruments (P.O. Box 126, Fort Worth, Tex. 76101). Most bells come with handles. That was true of these bells. Clearly bells with handles are not readily usable with this BALANCE and MUSIC integrating product. [NOTE: Rhythm Band Instruments also sell a “desktop” version, but it appears that these would have to be revamped also to render them compatible for use with the Giant Musical Balance Board. They also sell sets with varying numbers of bells including a set of 13, which would integrate all of the white and black notes of a scale's range.]

Here are a few considerations which need to be kept in mind to ensure that the bells used are compatible for use with this product. 1. For use in this capacity the bells cannot be in their most common form where they are held aloft by a handle at their top. They must be in a form where they are MOUNTABLE ON A SURFACE (in this case the top surface of the balance board) and at a low enough height where they can be pinged/sounded via contact with a somewhat smallish ball such as a golf ball. 2. The bells need to have a BOTTOM SIDE not only for placement on a surface but also so that the “hook” side of a “hook and loop” product can be affixed to it. 3. The bells need to have a STURDY construction so that they can withstand repeatedly being ripped free from their “hook and loop” connection. [Note: They would not need to be so sturdy perhaps if a tacky/Dysem® sort of attachment system were utilized.] 4. Yet, the bell portion must remain somewhat LOOSE in order for it to vibrate/sound freely. 5. Because the sounding portion must both be kept somewhat loose and is often made of thin metal, it is somewhat delicate and should not be grabbed directly. Therefore, the bells used with this product need to be designed in such a way that the user INTUITIVELY GRABS FOR SOMETHING OTHER THAN THE BELL ITSELF when he desires to move it.

FIGS. 5a and 5d show two iterations of a “hand bell” revamped to meet all of the preceding criteria so as to be rendered suitable for use with The Giant Musical Balance Board. FIG. 5a shows a form that could be made with readily available materials. The top rounded piece in FIG. 5d may by harder to find ready-made and may have to be specially machined or molded. For added safety with this iteration—i.e. FIG. 5d—the rounded cap could have a cover of foam attached to it perhaps via a “hook and loop” means. Also, it should be noted that —if the required initial expenditures are not prohibitive—the bells could be much more easily and quickly assembled if the nut and bolt structure shown were made instead from one solid machined or molded piece of metal or plastic. And even if it were not deemed feasible —economically or otherwise—to mold or machine the entirety of the above so that it were all one solid piece, if at least the portion represented by the five lower glued-together washers were replaced by one solid molded or machined piece, this would greatly simplify assembly (by eliminating the gluing steps) as well as (more importantly perhaps) eliminate the possibility of glue failure.

The ability to identify each bell's tone by a color may be beneficial for younger users and/or those with minimal music knowledge and interest. However, seeing as the connection between each bell's tone and its color is quite artificial and arbitrary, the bell colors really have no larger significance. Therefore, a facilitator will have to judge the benefit of this means of identification. Rather than relying on a bell's color, it may be deemed more beneficial for users to learn each bell tone note's name. The label system shown in FIGS. 6a-7b would enable a user to identify a bell's tone with its note's name without needing to rely on color. In such a case colored bells would not even be necessary, for a user could see from above—i.e. on the label affixed to the top of a bell—the name/letter of the note played by the bell. [Note: Or, instead of identifying each bell by the name of the note it plays (i.e. “C” or “D” or “Gb”, etc.) each bell's label could identify it by its sequence in a scale (i.e. “I” or “2” or “5”, etc.), or a bell's label could even identify it by showing the note as it would appear on the five lines or four spaces of the musical notation staff.] Another benefit of a colorless bell system is that—since all the bells would look much more alike—it may not be necessary to conceal bell color with the bell-color-concealment caps (shown in FIGS. 7a and 7b). As mentioned earlier, one of the main reasons for concealing bell colors was to prevent more musically inclined users from being able to figure out a song while skipping the balance portion of the activity. If all the bells were more similar in appearance—and the labels used were absent of any note identification—musically gifted users would have to actually ding the bells to figure out the song.

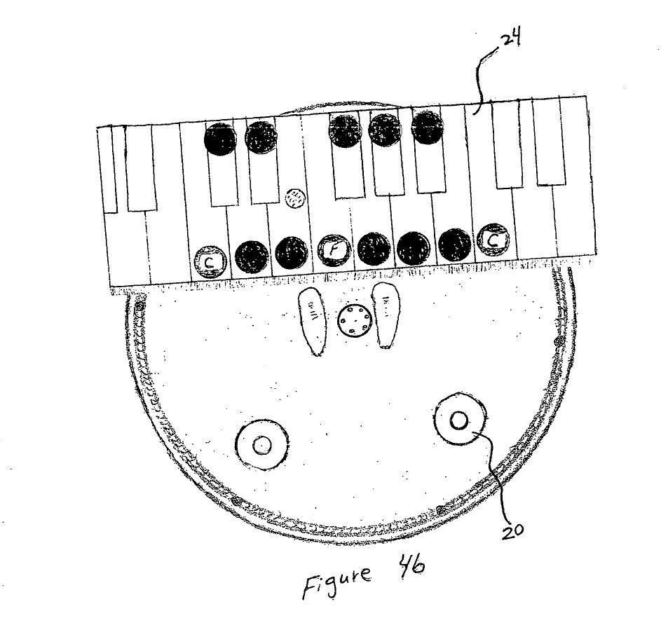

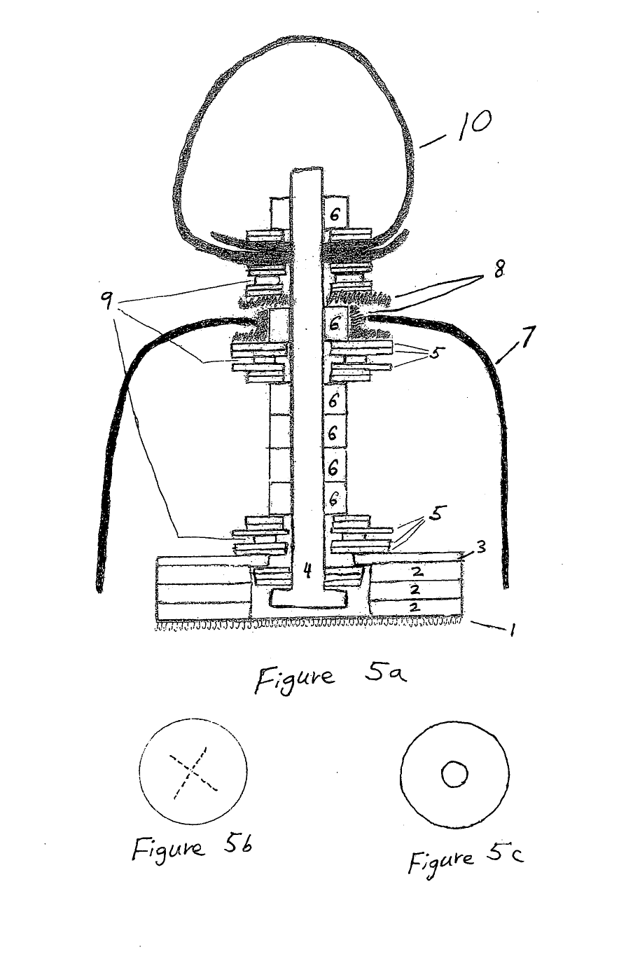

Besides bells (such as have been mentioned hitherto) there are many other props —capable of being “tripped” by a ball to emit sound or light or otherwise reward the user in an audio or visual way—which are readily usable with or could easily be adapted for use with this unique balance apparatus. For example, many portable, plastic mini-golf sets have props that would be/could easily be made to be usable with this versatile product. The add-on example of a piano keyboard section as depicted in FIG. 4b should suffice to illustrate the vast range of possibilities enabled by this incredible integrative balance training apparatus.

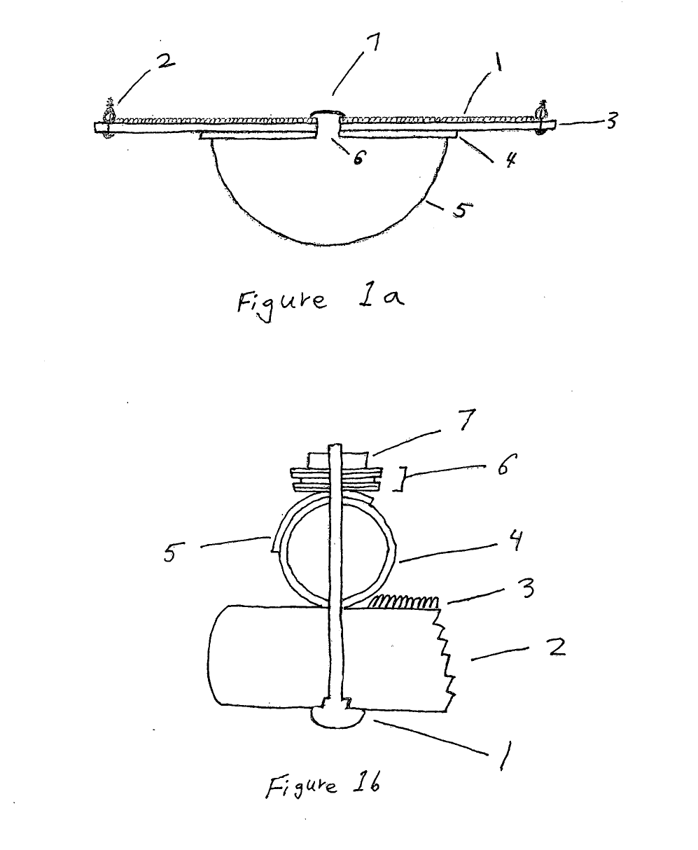

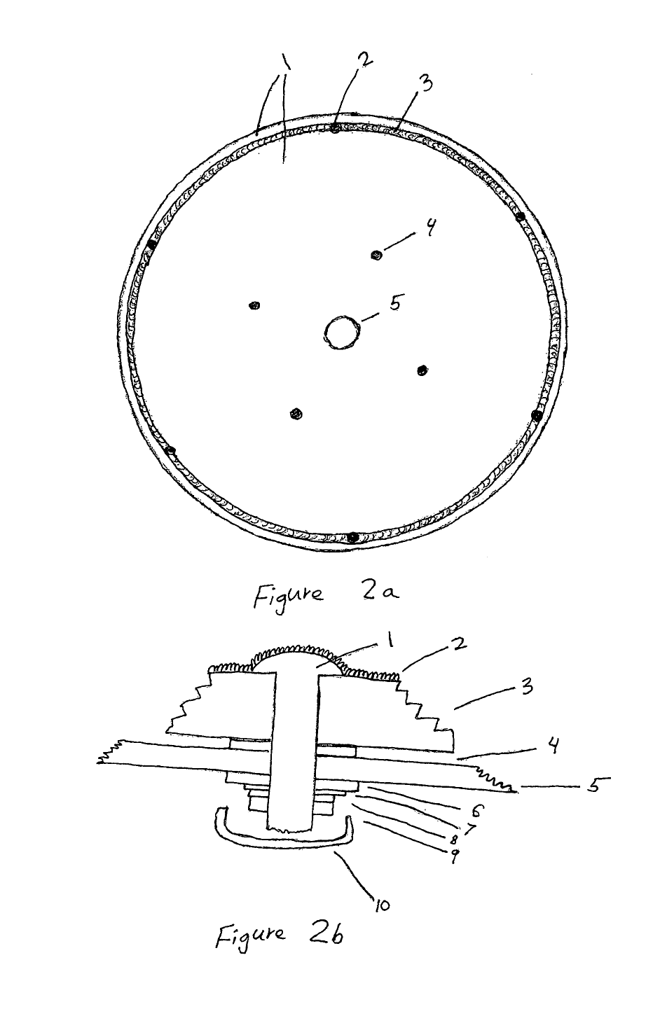

FIG. 1a (expanded description)—side view of assembled apparatus cut in half with the following descriptions: 1 (“loop”-functioning carpet on the platform's surface); 2 (rim near the platform's periphery secured in six places with six carriage bolts); 3 (rigid platform made of plywood or other suitably rigid material); 4 (hard plastic base of a BOSU® ball); 5 (rubber bladder of a BOSU® ball); 6 (hole in center to allow access to pump up the BOSU® ball's rubber bladder); 7 (pry-up style cover plate to both cover hole—so that the ball can roll over it—and to allow access to pump up bladder)

FIG. 1b (expanded description)—detail of number 1 in FIG. 1a with the following descriptions: 1 (2.5″× 5/16″ carriage bolt); 2 (plywood platform base); 3 (carpet affixed to the platform's top surface which functions as the “loop” complement to the “hook” side affixed to the base of each moveable prop (bells, etc.); 4 (1 inch tall plastic tube forming the circular rim near the periphery of the platform's surface); 5 (about a two inch piece cut out of same plastic tube material functioning as a form fitting “washer” to help spread out the pressure and thus enable the carriage bolt to be tightened beyond what it could otherwise be without cracking or deforming the rim. Notice that it does not extend as far down on the inside side lest it hinder the smooth rolling of the ball around the periphery); 6 (two ¼″ washers above and two ¼″ washers below a ⅜″ lock nut); 7 (one 5/16″ nut)

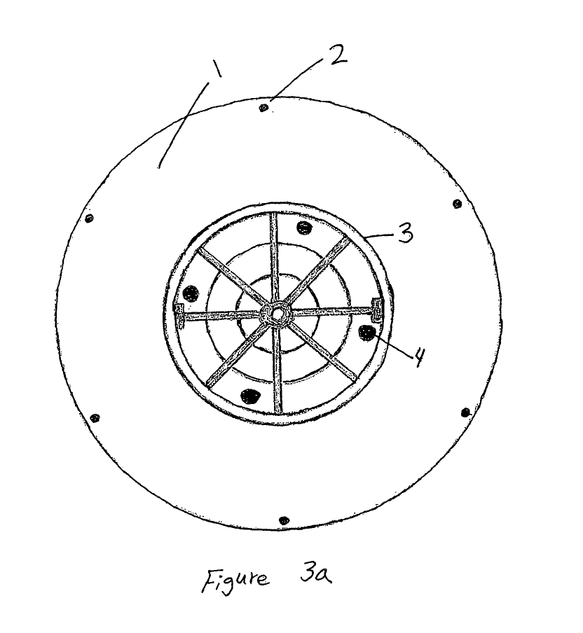

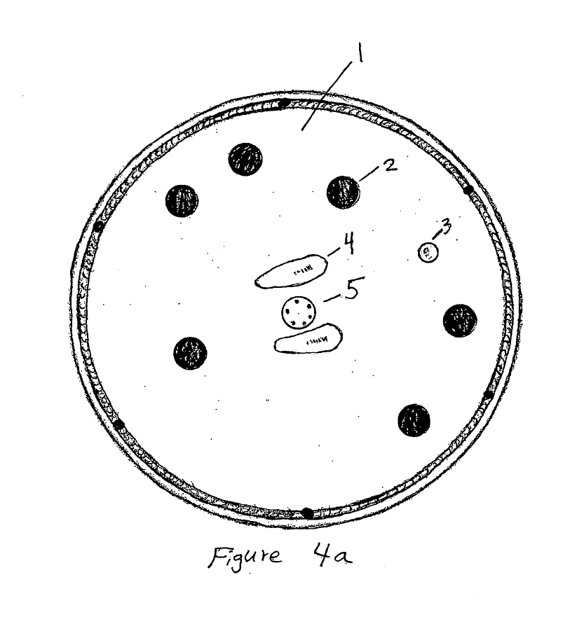

FIG. 2a (expanded description)—top side view with carpet removed and with the cover plate over the center hole removed and with the following descriptions: 1 (plywood platform surface which in the preferred embodiment is circular and of a substantive diameter); 2 (one of six equidistant 2.5″× 5/16″ carriage bolts securing the raised rim to the platform's surface —head side down); 3 (the raised rim); 4 (one of four 1.5″× 5/16″ carriage bolts serving to secure the BOSU® ball to the underside of the platform—head side up); 5 (the hole cut out in the center to allow access to pump up the rubber bladder of the BOSU® ball—seen with the cover plate removed)

FIG. 2b (expanded description)—detail of number 4 in FIG. 2a with the following descriptions: 1 (one of four 1.5″× 5/16″ carriage bolt used to secure the BOSU® ball to the platform); 2 (“loop” carpet affixed to platform's surface which covers the heads of all four of these carriage bolts so that they are not visible from the top side); 3 (platform surface plywood); 4 (one ½ ″ washer because a spacer is needed between the platform's plywood and the hard plastic base of the BOSU® ball in order to have enough room to accommodate reattaching the rubber bladder of the BOSU® ball to its hard plastic base after first securing this base to the platform's underside. If one ½″ washer does not provide enough room, use two.); 5 (the hard plastic base of the BOSU® ball); 6 (another ½″ washer); 7 (one 5/16″ washer); 8 (one 7/16″ lock washer); 9 (one 5/16″ nut); 10 (a plastic cap placed over protruding end of bolt prevent it from potentially damaging or even puncturing rubber bladder; a plastic pop bottle cap will work)

FIG. 3a (expanded description)—underside view of apparatus with the hard plastic base of a BOSU® ball centrally attached to the bottom of the platform and with the following descriptions: 1 (underside of rigid plywood platform); 2 (one of the six 1.5″× 5/16″ carriage bolts referenced previously which are used to secure the hard plastic base of the BOSU® ball to the underside of the rigid plywood platform. Note that the rounded head of the carriage bolt is on this underside so that there is such minimal protrusion as will eliminate the likelihood of any contact of this bolt with the ground); 3 (the hard plastic base of the BOSU® ball with the rubber bladder removed as is necessary in order to secure the BOSU® ball to the platform; Note that the bladder is reattached after this hard plastic base piece has been thus secured to the underside of the platform); 4 (points to one of the four places where the 1.5″× 5/16″ carriage bolts are securing the hard plastic base of the BOSU® ball to the plywood platform)

FIG. 4a (expanded description)—top side view of apparatus with carpet attached and with the following descriptions: 1 (“hoop” functioning carpet covering top surface of the platform within the rim's perimeter and which also covers the heads of the four carriage bolts which secure the BOSU® ball beneath so that once the carpet is added these four carriage bolt heads are no longer visible); 2 (one of 6 bells shown on the platform's surface which are more randomly arranged and each of which has “hook” material attached to its underside so that it adheres to the carpet's “loops” and thus stays in place on the balance board's surface; none of the bells shown have identifying labels attached to their tops); 3 (a ball used to “ding” the bells); 4 (representation of the footprints of a user); 5 (pry-up style access plate covering the hole in the platform's center so that the BOSU® ball's pump-up site can be accessed when needed while allowing the ball to roll freely over the hole when this plate is in place)

FIG. 4b (expanded description)—top side view of apparatus similar to FIG. 4a but showing one of many potential add-ons that could readily be attached thus greatly increasing this unique balance board's integrative potentialities. This particular add-on (number 24) is composed of a 12 white key span of a piano keyboard with black notes included. As shown, it extends beyond the circumference of the board and thus would have to be raised a bit in order for it to thus extend over the raised rim. Thirteen bells are shown each with the tone corresponding to the key on which it sits. Only three of the bells shown have labels identifying the note/tone of the bell beneath. A ball used to ding the bells is seen on key E. It is not shown thus, but it would be best made with a raised rim to help in retaining the ball. Such keys could be printed on a carpet capable of functioning as the “loop” side of a “hook and loop” attachment system. [Or alternatively, a tacky, suction, or magnet based attachment system could be used to secure the bells.] For an add-on of this nature, using an electronic means to produce the tones would make it possible to have a much greater range of keys without needing to procure so many bells. Of course, the entire add-on could be made smaller to fit within the parameters of the main balance board's raised rim, but doing so would necessarily require sacrificing a bit on the size of the keys or the tonal range available to the user. Rather than being rigid as shown, a more flexible iteration/s of this add-on/prop could be provided which would be composed of fabric or another flexible material on which would be printed a similar design. Of course, in such a case it would have to be supported by the platform and, therefore, it could not extend over the edge—i.e. it would have to be small enough to fit within the circumference of the raised rim. Notice that weighted objects (number 20) are placed behind to offset the weight of the prop in front. A “hook and loop” or other attachment means would also be utilized to secure these lest they careen about the platform or—worse yet—injure the feet and ankles of the user. Also, the edge of the prop facing the user should be both closed off and tapered so that a user would not get his feet stuck under or his toe stubbed against the prop if he were to fall forward. Of course, rather than being an add-on that can be readily added or removed at any time, a similar keyboard design could be made a permanent component of the basic unit itself. For example, the piano keys shown could be printed on the carpet itself which covers the top of the balance board. However, most will probably find it desirable to have a basic unit which is simpler and “less busy” in nature to which extra-option “add-ons” can be added or removed as desired. Even apart from use with this keyboard print, there would be some advantages had by using electronic tone making devices instead of the protruding bells described herein. One advantage is that electronic tone making devices could be found and/or made in the form of ground-hugging pads which a ball could “trip”/sound simply by rolling over the pad. This would allow for more rapid ball movement and hence more rapid tone soundings and song creating speeds seeing as there would be fewer upward protruding objects to hinder the ball's movements. Such ground-hugging electronic pads—as well as electronic devices of a more upright nature—could also be programmed to electronically display colors and/or words and/or pictures so as to greatly facilitate interdisciplinary integration. Electronic devices capable of emitting tones, of speaking words, of displaying pictures and words could greatly facilitate the interdisciplinary benefits to be had by use of this BALANCE+MUSIC+ACADEMIC KNOWLEDGE integrating apparatus. But labels on bells will work as well. This product can fascilitate the discover-for-yourself learning of any information that can be linked:
Names of countries LINKED TO the continent on which they are found
Pictures of famous art pieces LINKED TO their names and/or creators
Names of country capitals LINKED TO the the countries in which they are found
Pictures of famous people LINKED TO their names
Names of famous people LINKED TO their accomplishments
Pictures of famous places or monuments LINKED TO their names or locations
Pictures of famous mountains or other places of interest LINKED TO their locations.
   This linkage-through music could be facilitated in a number of ways:
A willing participant could be instructed to link bell tone to bell tone in order to discover the link between the information displayed on/by each tone making entity (bell or electronic device) wherein two like tones will link two pieces of complementary information. This would require two bells of equal tone for every linkage desired. Two sets of scale-bells could link 8 things. But just one set of bells—containing a full scale—could be used in this way, for such a set would have two bells with the same tone (albeit an octave apart). The facilitator would include other bells containing decoy information—more or less of these, to attain the challenge level deemed appropriate for a given situation. Through such a means the answer to a multiple choice sort of ACADEMIC question could be figured out by a student by means of BALANCE and MUSIC.
Or a willing participant could be instructed to figure out and play the scale or a song, with the understanding that every two sequential notes will link two pieces of complementary information.
   In this way learners will have an activity-based option which can function as a strategic tool to motivate them towards joyful learning, and a means whereby students can be empowered—in a fun and active way—to discover knowledge for themselves.

FIG. 5a (expanded description)—top to bottom slice down the middle view of a BELL WITH WEBBED FABRIC HANDLE. This diagram shows a means—using readily available materials—whereby a handled bell hand bell can be converted into a surface mountable form thus making it compatible for use with The Giant Musical Balance Board and with the following description: 1 (“hook” side of attachment system affixed to the washer above via a sticky back adhesive); 2 (all three units labeled with the number “2” are two inch wide ¾″ washers); 3 (a ½″×2″ fender washer); 4 (a ¼″×3″ long hex bolt); 5 (all units labeled with a number “5” are ¼″×1″ fender washers); 6 (all units labeled with a number “6” are ¼″ nuts); 7 (this is the bell); 8 (lower and upper pieces of stiff felt each of which is described further in FIG. 5b and FIG. 5c respectively); 9 (three ⅜″ lock washers); 10 (a piece of webbed fabric about six inches long and with holes made centrally about a half inch from each end so that it can be doubled over upon itself and pushed down upon the shaft of the hex bolt in order to form a loop of webbing functioning as a handle); Note that the thirteen unmarked items are all ¼″ washers. Also, it is VERY IMPORTANT to note that it is necessary to glue or otherwise securely adhere ALL of the following five units together: the bottom three two inch wide ¾″ washers, AND the one ½″×2″ fender washer, AND the lowermost ¼″×1″ fender washer. It is only necessary that these five be adhered together; the rest should remain securely in place by simple nut-on-bolt tightening pressure.

FIG. 5b (expanded description)—a drawing of the lower piece of felt referenced in number 8 of FIG. 5a and with the following description: A piece of stiff felt traced from the circumference of a ½″×2″ fender washer. This piece of felt is cut in the middle as shown and then pushed down upon the ¼″ nut which it thus encircles in both a horizontal and a vertical orientation as can be discerned from a thoughtful consideration of FIG. 5a. This piece of felt serves to keep the metallic bell from undesirably contacting/clanging both the metallic washer below and the metallic ¼″ nut within.

FIG. 5c (expanded description)—a drawing of the upper piece of felt referenced in number 8 of FIG. 5a and with the following description: A piece of stiff felt traced from the circumference of a ½″×2″ fender washer and with a center hole cut out to allow its being pushed down upon the shaft of the ¼ hex bolt which it thus encircles as can be discerned from a thoughtful consideration of FIG. 5a. This piece of felt serves to keep the metallic bell from undesirably contacting/clanging the metallic washer above.

FIG. 5d (expanded description)—Same as FIG. 5a above minus the topmost two washers and the topmost nut the latter of which is replaced by (see number 10 in diagram) a smooth, rounded cap threaded internally to receive the top protruding shaft of the 3″×¼″ bolt. An embodiment such as this may be desirable for safety reasons in that falling upon a blunter and smooth surface such as this would appear less likely to result in injury versus the form shown in FIG. 5a.

FIG. 6a (expanded description)—Same view as figure Sa with a few additions explained below: 11 (“hook and loop” attachment means shown with one side connected to the orb below and the other side connected to the base of the cushioned cap above; 12 (cushioned cap to protect from injury anyone who might fall upon the top of the bell apparatus; 13 (“hook and loop” based attachment means shown with one side connected to the top of the cushioned cap below and the other side connected to the bottom of the label holder above); 14 (This is a clear-topped label holder into which can be inserted a vast assortment of informational labels for integrative/interdisciplinary purposes. Two or more different sizes of label holders should be made available to accommodate both smaller and larger labels, but the size shown extends beyond the edge of the cushioned cap so it needs to be rigid enough so that it does not droop, yet is should probably have a bit of flexible for safety reasons in case a user falls upon it. The cushioned caps are optional for labels can be attached directly to the orbs themselves if one chooses not to use the cushioned caps. This label holder is attached via a “hook and loop” attachment means to the top of the cushioned cap so that the user can see from above the information displayed therein. Of course, other attachment means such as magnet-based could also be utilized.); 20 (depiction of a golf ball recommended for bell dinging purposes although many other round objects would work as well.) [Note: Of course, if one chooses to forego the added safety provided by the cushioned cap, it would be possible to not use/bypass the cushioned cap and attach the label (number 14) directly to the orb itself (i.e. number 10 topped with the “loop” side of number 11).]

FIG. 6b (expanded description)—Topside view of numbers 12 and 14 in FIG. 6a and also showing the following: 17 (a label whereon the name “George Washington” has been written which label has then been inserted into the label holder so that it is visible through the label holder's clear top.) [Note: Label holders compatible for use with this product should probably be made available in two or more sizes. For example, it would be desirable to have a larger label holder for displaying the name “George Washington”, and a smaller one for displaying a bell's tone/note (i.e. “C”, “D”, “Eb”, etc.). Labels are not always needed or desired. But when they are used to facilitate a particular challenge, the main thing is that they be large enough to be clearly seen by the user.]

FIG. 7a (expanded description)—Same as FIG. 6a with one addition explained below: 15 (a bell-color-concealment cap is attached via a “hook and loop” attachment means to the top of the cushioned cap and then the clear topped label holder—i.e. number 14—is shown attached to the top of this bell-color-concealment cap once again via a “hook and loop” attachment means. [Notes: Bell-color-concealment caps that are about 5″ in diameter and that come down a bit on the sides should suffice to adequately hinder an erect user from too easily being able to discern the color of the bell beneath; note, however, that they cannot come down so far as to hinder the ball from dinging the bell. Of coarse, another attachment means could be used instead of “hook and loop” such as (for example) one that is magnet-based. Bell-color-concealment caps such as these can serve to broaden the integrative range and heighten the challenge potential of this unique integrative balance tool as will be made clear by some of the examples following.]

FIG. 7b (expanded description)—Top view of FIG. 7a showing once again the label holder with inserted label seen earlier in FIG. 6b, but this time this label holder is attached to the top of the bell-color-concealment cap.

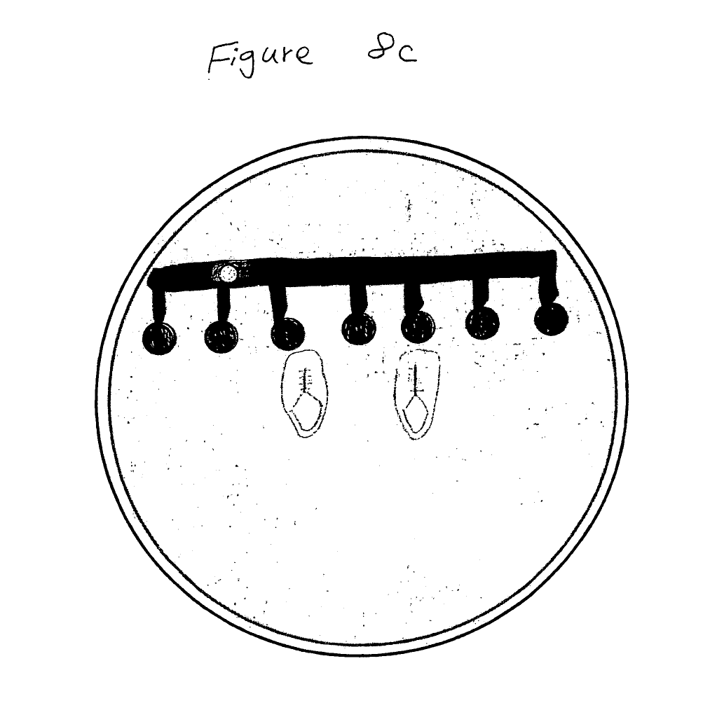

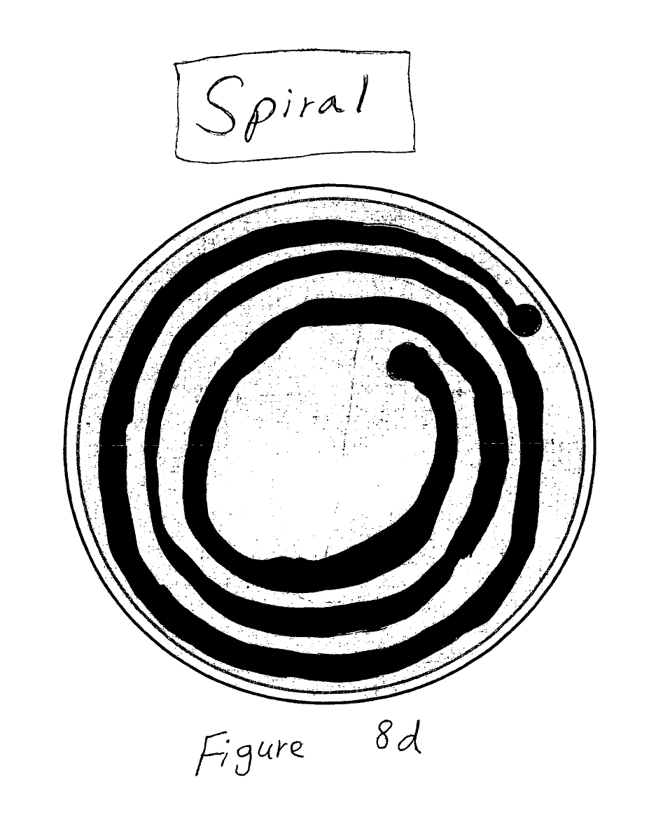

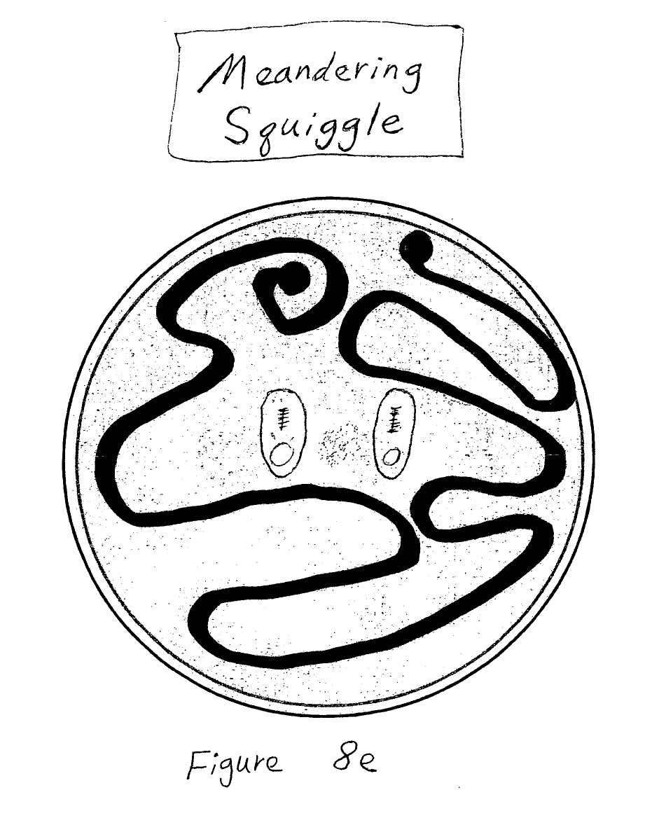

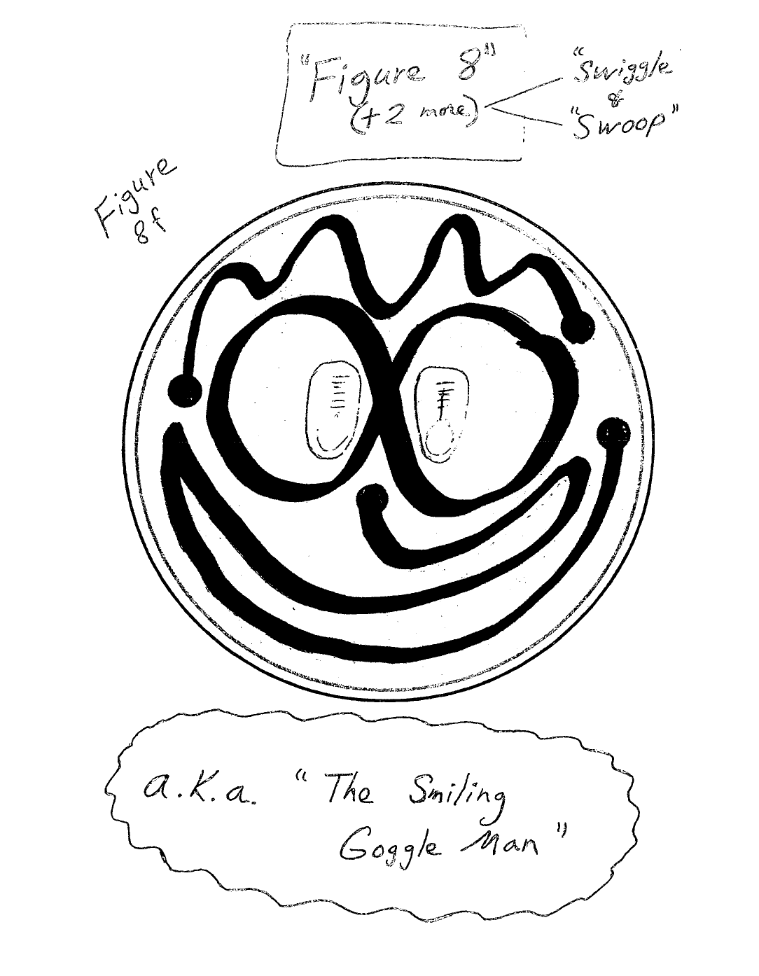

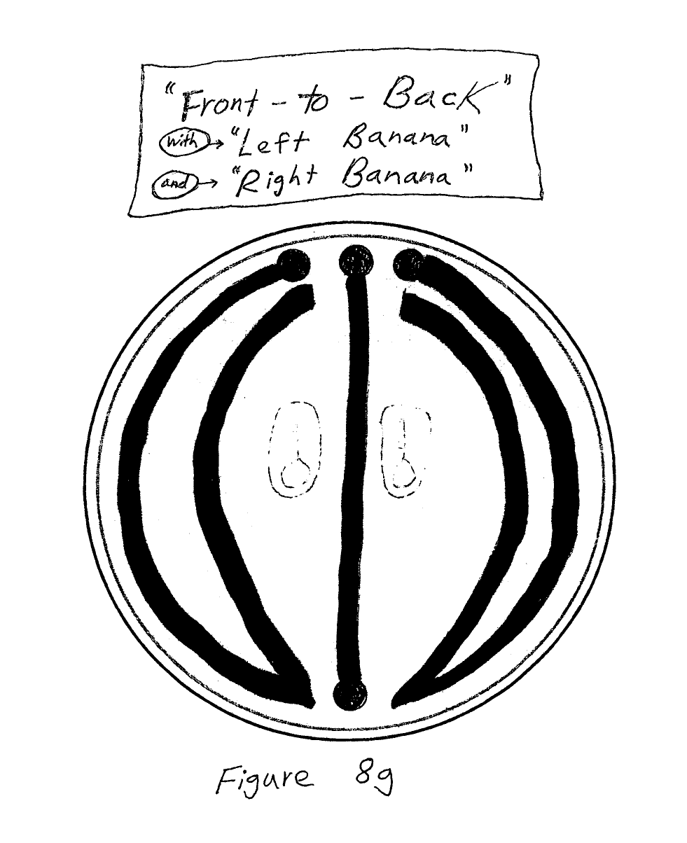

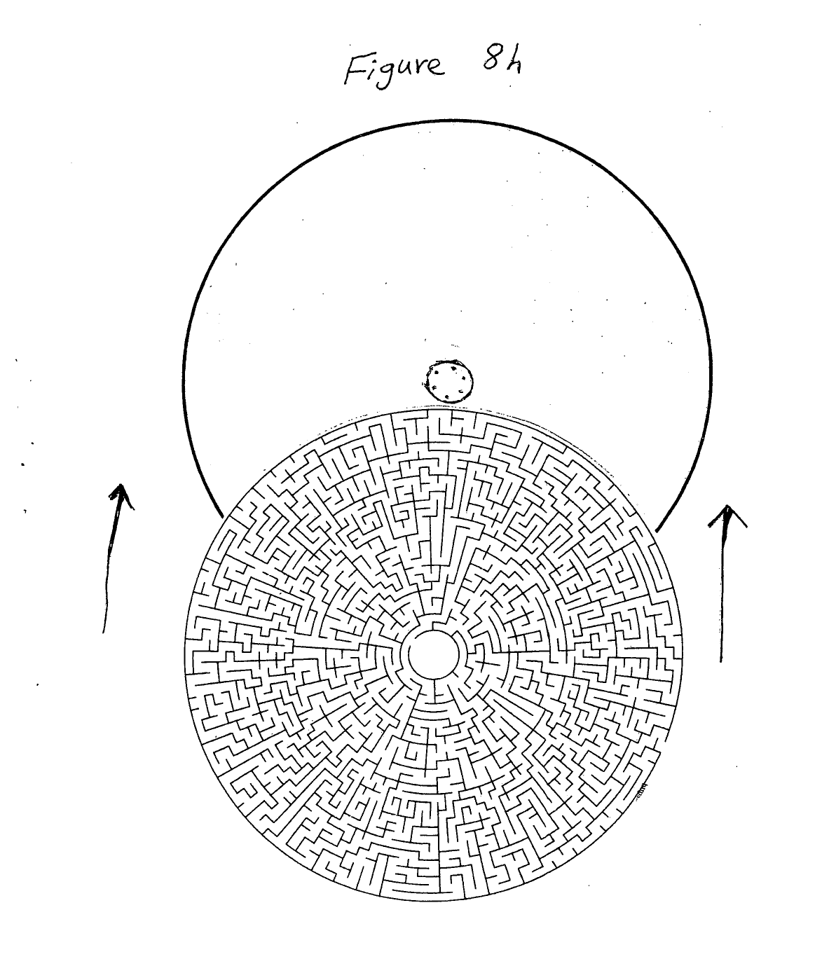

FIG. 8a (expanded description)—“USA” . . . BALL-GROOVE PROP This diagram illustrates one of many possible fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped. Grooves—as represented by the lines/dashed lines—could be routed in a board (made of wood, plastic, or a plastic-paper composite, etc.) in which grooves a ball would roll as directed by a person's balancings. Having such a “path” for a ball to track through would be easier than a person attempting to trace a similar pattern using a totally free-rolling ball and would thus prove an effective means to engage and challenge novices to improve their balancing skills in preparation for more difficult challenges. This example features a continuous groove forming the letters “USA”. [Note again that it is a continuous groove—the dotted line is only used to show those portions of the groove which interconnect the letters.] The groove itself would be substantively the same from one end to the other. However, to help the letters themselves stand out and not be obscured by the interconnecting lines, a cosmetic distinction would be desirable. This could be accomplished, for example, by painting the letter portion of the groove while leaving the interconnecting groove unpainted. The add-on and supplementary BALL-GROOVE BASED “prop” shown would be placed on the surface of the balance board within the circumference of the raised rim. [Note that the rim is not shown in the picture.] However, it should be noted that any such prop if raised up so as to extend over the raised rim could actually extend a substantial distance beyond the circumference/be of a substantially greater diameter than the surface of the balance board it is piggybacking. In the interests of utilizing the full size of the “prop” shown, a STRAIGHT LINE has been added above the USA and a SQUIGGLY LINE has been added beneath. The round orbs at both ends of each groove represent bells that can thus be utilized to give audible encouragement and confirmation upon successful completion of a maneuver. There are many ways in which the ball-groove prop shown could be altered if desired. For example, if it were deemed desirable to never have to “backtrack” or to trace a word or acrostic backwards, the beginning and termination of the USA ball-groove pattern could be interconnected so as to allow it to be traversed in a continuous loop and always in a left-to-right letter direction—i.e. a user could always trace out U (then) S (then) A and would never have to go backwards/in reverse order. Of course, major alterations to the pattern shown in FIG. 8a would have to be made to accommodate the changes mentioned above. For example, the bottom SQUGGLE would probably have to be dropped to allow room for the termination point of the “A” to be interconnected to the start point on the “U”. Also in such a continuous loop case the bells could still be used as audible milestone markers but they would have to be repositioned so that they only extend into the “path” far enough to be dung by the passing ball but not so far as to hinder the movement of the same. Another point to keep in mind regarding this (or any such) full-board prop: if the ball's movements are intended to be directed by the balancings of a person standing atop, consideration will have to be made for the placement of a person's feet—i.e. there will have to be room for the person to stand. Some letters (such as an “M” in the middle) will easily accommodate such, and some shapes likewise will do the same (such as a FIG. 8 shape which would go nicely around and between a user's feet). But, no doubt, in some cases accommodations will have to be made. For example, to avoid any such potential difficulty, the letters “USA” could all be moved up so that they are ahead of center where the user will normally need to stand. [Note: If a weight were placed on the surface of the board above the “USA” (i.e. if an appropriately sized weight were placed where the BACK AND FORTH line is presently shown) a user could stand further back from center and thus perhaps successfully ameliorate the ball-path-blocking potentiality mentioned above.] In such a case, of course, the letters would have to be made a bit smaller, but they would still be relatively large. Also, in such a case the BACK AND FORTH line as presently shown would have to either be dropped or moved elsewhere to make room for the repositioned (and resized) “USA”. Of course, any such add-on prop should be equipped with enough “hook” material on its back side to cause it to adequately adhere to the “loop” functioning carpet on the balance board's surface without sliding about and yet not so much as would render it too difficult to remove; and any offsetting weights used as mentioned above should be sufficiently secured (utilizing “hook” means or otherwise) to prevent them from careening into the user's ankles. And finally, any prop described herein as being of an auxiliary or add-on nature could, of course, be permanently integrated; however, doing so would limit the vast variability made possible by this product.

FIG. 8b (expanded description)—SCHOOL LETTER (“NSU) . . . BALL-GROOVE PROP

This diagram illustrates another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped. The BALL-GROOVE BASED “props” shown in FIGS. 8b-8g are seen as they would appear after being added/mounted to the surface of the balance board (with the exception that the raised rim which is present in actuality has been left out of the figures). For more insights applicable to this “NSU” example as well see FIG. 8a above.

FIG. 8c (expanded description)—MUSICAL SCALE . . . BALL-GROOVE PROP This diagram illustrates yet another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped. This example is of a groove cut in such a way as to assist a user in accessing an entire scale of toned bells in an easier and more controlled manner than is the case with a free-rolling ball. [Note that there should be eight bells rather than only seven.] Of course, such a BALL-GROOVE PROP could easily be altered to include the black notes also so that the bells representing the flats and sharps also could be “played by balance”. For more insights applicable to this example as well see FIG. 8a above.

FIG. 8d (expanded description)—SPIRAL . . . BALL-GROOVE PROP This diagram illustrates yet another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped. For more insights applicable to this example as well see FIG. 8a above.

FIG. 8e (expanded description)—MEANDERING SQUIGGLE . . . BALL-GROOVE PROP

Yet another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped. For more insights applicable to this example also see FIG. 8a above.

FIG. 8f (expanded description)—FIGURE EIGHT+SWIGGLE & SWOOP . . . BALL-GROOVE PROP (a.k.a. THE SMILING GOGGLE MAN)

Yet another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped. Some examples of variations to consider: The top and bottom shapes could be joined on the right side so as to form a longer path for a ball to “traverse”, or on both sides so as to form a continuous loop. As mentioned in the description of FIG. 8 above bells could still be utilized with the FIG. 8 or with any continuous loop by positioning a bell far enough into the ball's path to be dung by the passing bell but not so far as to hamper the ball's movements overmuch. For more insights applicable to this example also see FIG. 8a above.

FIG. 8g (expanded description)—FRONT-TO-BACK+LEFT BANANA & RIGHT BANANA . . . BALL-GROOVE PROP

Yet another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped. Any of these shapes—such as the Front-To-Back shown in this figure—could, of course, be performed “free ball” with bells similarly placed fore and aft. However, a grooved “path” as such a prop provides makes such a task more easily performed by novices at an earlier stage. Also, accomplishing such a task on a grooved “path” makes accomplishment of the task more visible and concrete in nature providing greater motivation and incentive for younger users especially. For more insights applicable to this example also see FIG. 8a above.

FIG. 8h (expanded description)—MAZE . . . BALL-GROOVE PROP

Yet another example of the great variety of fun, interesting, and challenging supplementary/auxiliary/add-on BALL-GROOVE BASED “props” made possible by the substantive size of and the integral “hook and loop” attachment system with which the preferred embodiment of the Integrative Balance Board Training Apparatus is equipped. This figure of a maze will also serve to represent the possibility of integrating a ball-navigated labyrinth-like prop onto the surface of this balance device—wherein the two knobs normally used with such recreational devices of a small scale (to control the tilt of the surface and hence the movement of the ball) are rendered unnecessary by the balance board's tilt ability making feasible a much larger field of play. For more insights applicable to this example also see FIG. 8a above.

It should be noted that any specifics mentioned above in this application should not be construed as restricting the natural and reasonable scope of this invention. For example, the raised rim should be made higher or lower as required to adequately retain a given ball size within the circumference of the rim. A shorter rim would adequately retain a smaller ball, but a taller rim would be necessary to accommodate a larger ball. For example, a rim 1.25″ or so high would ideally serve to retain a golf ball/a golf-ball-sized ball.

A note of clarification: For purposes of the following claims, ANYTHING BEYOND that which is herein deemed to be the essence of a wobble board—namely, “a destabilizing, all-direction-tilt-enabling entity”—is considered to be an “add-on”. In other words, that which heretofore has often been referred to as a “prop” will be referred to as an “add-on” in the claims—including even the basemost platform which heretofore was not termed a “prop”. This essential element of a “wobble board” will be referred to as “a destabilizing, all-direction-tilt-enabling entity”. Such an entity can take many forms. In the preferred embodiment this shape could basically be described as a half-ball shape such as is reflected in a BOSU® ball's SHAPE.

However, it should be stressed that although the SHAPE of the preferred embodiment's “essential entity” is relatively stable, the SIZE/S of this same said shape applicable to this invention could vary—even dramatically. So, an “add-on” can be (not an exhaustive list) a bigger item—such as a labyrinth, or a board containing grooved “paths” for a ball to trace, or a panel containing a depiction of a piano keyboard—or a smaller item such as a bell. For purposes of the claims, the former would all be considered and could be referred to as “panel-add-ons” and/or as “add-ons”, but latter (the bell) would be considered just an “add-on”. But all “add-ons”—whether a panel or not—will be supported by an “essential entity” either directly or indirectly. Actually only the primary-panel-add-on” will be in DIRECT contact with the supportive, all-direction-tilt-enabling “essential entity” beneath, but all else, nonetheless, will be supported thereby. The basemost panel-add-on (alternatively referred to as the “primary-panel-add-on” or the—i.e. the panel-add-on which is in most direct ASSOCIATION with the all-direction-tilt-enabling entity—could be ASSOCIATED with such in many ways, such as by being CONNECTED thereto (as in the preferred embodiment); or the primary-platform-add-on could be ASSOCIATED with the essential entity by means of PIVOT POINT CONTACT. So although CONNECTION is a means whereby the basemost platform can be directly ASSOCIATED with the essential entity, it is not the only means. And the possibilities presented by some of these other means—especially water SUSPENSION as will be discussed below—as it relates to this application are intriguing. The primary-panel-prop could be directly associated with an essential entity by means of being SUSPENDED therein—as is the case when a liquid is functioning in the “essential entity” capacity as the “destabilizing, all-direction-tilt-enabling entity” enabling the apparatus to bobble about in all directions. Of course, the primary-platform-add-on in such a case must of necessity float. Such a “floating wobble platform” could be small—such as could fit on a table in a bowl manipulated by the user's/users' fingers or (for example) chopsticks whereby the “floating wobble platform” could be manipulated about to direct the motions of a ball atop the platform; or such a “floating wobble platform” could be much larger so as to necessitate a pool of water to contain it and require 2, 3, or 4 or more people to cooperatively manipulate the tilt of the floating wobble board with long sticks in order to direct the ball to move about to ding bells, or to navigate a maze or labyrinth contained upon the wobbling floating platform/panel, or one or more people could be atop the same cooperatively manipulating the all-directional tilt of the floating wobble platform/panel to move a ball about upon the same. Another SUSPENSION based means of association with an essential entity support would be a platform suspended by ROPES whereby (for example) a four sided platform could be suspended by four ropes each rope being connected to a side or corner of the platform, each rope then being looped each through its own pulley overhead, the ropes then extending to the ground to be tugged by two or more people to tilt the platform and thereby direct the movements of a ball/s upon the surface. Similarly with a circular platform or triangular shaped platform—although such a triangular-shaped platform (and perhaps the circular as well) would probably be best manipulated with just three ropes thus suspending via pulleys the platform. It should however be pointed out that in such a case the ropes would need to have a limiting mechanism to keep the platform from potentially crashing dangerously to the ground. Another rope-based platform suspension system—whereby a platform could be ASSOCIATED with an essential all-direction-tilt-enabling entity by means of being associated thereto via SUSPENSION (in this case via ropes)—could take the form of a platform being suspended by a rope attached centrally from above—i.e. a sort of rope-pivot-point-based suspension system wherein the platform is in a sense “pivoting on a rope”. In such a case, side-connected ropes could be attached to different shaped platforms the same as mentioned above—and even still using an overhead-pulley system if desired—which pulley system would allow for the platform to be at a lower height than would be the case if people were manipulating it directly by holding it from the sides. However, situated thus it may tend too much to sway, and, having it suspended at a height whereby people can directly engage the platform from the side may be best.

It should also be pointed out that an add-on can itself contain another add-on. An add-on such as a bell can contain upon itself another add-on such as a label. A panel-add-on can contain upon itself a bell add-on. Or a panel-add-on can have another panel-add-on upon itself such as in the drawings showing the grooved “trail” panel-add-ons (previously referred to as “props”) which were pictured as being placed upon the primary-panel-add-on. Concerning this latter point, those grooved “trail” panel-add-ons could themselves be attached directly to that half-ball functioning as the essential entity. However, since in those illustrations the primary-panel-add-on was described as being bolted to the half-ball, it would be much quicker in such a case to place the grooved “trail” panels atop the primary-panel-add-on. However, if a more readily attachable/detachable attachment system were used—for example if a “hook and loop” based or a magnet-based attachment system were utilized as the means of attaching panel-add-ons to the half-ball, instead of nuts and bolts—then other panel-add-ons could be attached directly to the half-ball without needing to be staged atop a primary-platform-add-on. It would simply be a matter of 1. placing a sufficient amount of“hook and loop” attachment material on the half-ball's flat side, and then 2. placing complementary “hook and loop” material on the underside of a panel-add-on and/or of a primary-panel-add-on—and the panels could quickly be added/removed/exchanged. One advantage this approach would be that it would allow people to use half-balls which they may already own thus enabling them to purchase the rest of the apparatus's accoutrements at a cheaper overall price. Using a “hook and loop” or magnet-based attachment system involving a customer's own half-ball, however, would be greatly facilitated by sending the customer BOTH attachment material—such as “hook” or “loop” fabric or magnets—AND a template to enable him to properly align those materials seeing as he must needs apply them to the flat side of his balance ball so that they properly align with their complimentary opposites which would come pre-affixed to the panel-add-ons arriving from the factory. Another option to enable a customer to save by using his own balance ball/essential entity would be to provide him with a framework which could be made so that it would snugly tighten onto the flat base of a standard balance ball, and would have a flat panel upon itself situated parallel to the flat base of the half-ball upon which flat base “hook and loop” material could be placed corresponding to its complement which would arrive factory-attached to the bottom of each panel-add-on purchase. Or the framework could have bolt holes which correspond to bold holes pre-drilled in the panel-add-ons arriving from the factory. Or the said framework could be made having a top which interlocks with its complement which is factory-attached to every panel-add-on purchased. Or a more permanent alternative would be to provide the customer with a bottle of glue whereby he can attach his own balance ball to a purchased panel-add-on. Better yet it would be in such a case for him to attach his balance ball to more of a PRIMARY-panel-add-on seeing as primary-panel-add-ons allow for the staging and exchanging of additional add-ons and panel-add-ons upon themselves whereby a greater variety of balance challenges can be experienced. One advantage of the framework means would be that spacers could be provided which could be readily added between the framework and the panel-add-on above WHEREBY A GREATER HEIGHT OFF THE GROUND COULD BE ATTAINED TO ACCOMMODATE LARGER PANEL-ALL-ONS ABOVE—for the wider the platform is the higher it must be raised off the ground to enable an adequate range of tilt ability. Indeed, the large primary-platform-prop affixed more permanently to the BOSU® ball in the drawings presented with this application could in fact be affixed to that same such rounded, balance-challenging/instability producing object” in a manner less permanent than the bolted on means shown. Instead the bottom of this platform-add-on could have “hook” material affixed to it and the flat side of the BOSU® ball could have “loop” material affixed to it (or visa versa) so as to render them joinable in a less permanent/more readily detachable way rather than by using nuts and bolts. Likewise, magnets or other less permanent means of joining the same could be utilized. Similarly, the platform-add-ons containing a maze or a labyrinth or grooved and/or raised rim “paths” for a ball to trace—instead of being placed atop the raised-rim primary-platform-add-on as in the illustrations—could instead be attached directly to a “rounded, balance challenging/instability producing object” such as a BOSU® ball either via a more permanent nut and bolt or adhesive based means or—more desirably if changeability is desired—via a less permanent “hook and loop” or magnetic-force-based means. Furthermore, for purposes of the claims please note that what has heretofore been described as primary-platform-add-on is also—and may therefore be referred to as—a “platform-add-on” or (even more fundamentally/simply) as an “add-on”; likewise a platform-add-on—being also an add-on—may be referred to in this more fundamental ways also an add-on. Note also, that platform-based entities to be regarded as “platform-add-ons” can come in many shapes and sizes. For example, the rectangular keyboard in FIG. 4b is to be regarded as a platform-add-on, and if such were directly attached to an essential entity such a panel-add-on would be regarded as the primary-platform-add-on while associated thus to an essential entity.

### REFERENCES (INCORPORATED HEREIN BY REFERENCE)

Not applicable.

I claim:

1. A wobble-board-type of apparatus composed of an essential destabilizing, all-direction-tilt-enabling entity, which essential entity is associated with and is fundamentally supporting the rest of the apparatus, and one or more add-ons associated also with one another of which add-ons there is at least one platform-add-on, and at least one rolling ball upon the surface of the apparatus whose movements thereon are directed by the platform-tilt-controlling actions of the user/s.

2. The at least one platform-add-on of claim 1 whereof said add-on's surface contains one or more grooved and/or raised rim “paths” wherein said “paths” the at least one rolling ball is intended to roll.

3. The at least one platform-add-on of claim 1 whereon said add-on's surface the at least one rolling ball is intended to roll about in a more free-roaming manner.

4. The at least one platform-add-on of claim 1 whereof said add-on has a raised rim which raised rim extends in six inches or less [6″ or less] from the said platform-add-on's periphery all around, and which raised rim is for the purpose of assisting the user/s in retaining the at least one rolling ball of claim 1 within the rim's perimeter.

5. The essential entity of claim 1 whereof said entity is a liquid solution, and which said entity is associated with and supporting the rest of the apparatus by means of the same being suspended therein.

6. The essential entity of claim 1 whereof said entity is at least one rope, and which said entity is associated with and supporting the rest of the apparatus by means of the same being suspended therefrom.

7. The essential entity of claim 1 wherof said entity is a rounded object beneath which is associated with and supporting the rest of the apparatus above.

8. The associated items referenced in claim 1 whereof one or more of said items is associated with that to which it is most directly associated by means of being attached thereto, and whereof the said attachment means is of a quickly attachable/detachable nature.

9. The nature of the attachment means referenced in claim 8 is of a tacky/friction-based nature.

10. The nature of the attachment means referenced in claim 8 is of a suction-based nature.

11. The nature of the attachment means referenced in claim 8 is of a magnetic-force-based nature.

12. The nature of the attachment means referenced in claim 8 is of a “hook and loop”-based nature.

13. The surface referenced in claim 1 wherein the platform-add-on comprising the working surface in primary use by the at least one rolling ball at any given time is three inches or more [3″ or more] wide at its widest point.

14. The surface referenced in claim 1 wherein the platform-add-on comprising the working surface in primary use by the at least one rolling ball at any given time is three and a half feet or more [3.5′ or more] wide at its widest point.

15. The one of more add-ons referenced in claim 1 whereof one or more of said add-ons are platform-surface-mountable, sloped-edge “holes” whereby a golfing sort of activity is integrated with the platform-tilt-controlling actions of the user/s.

16. The one or more add-ons of claim 1 whereof 3 or more of said add-ons are platform-surface mountable add-ons capable of emitting musical note tones which tones can be sounded/‘triggered” by the at least one rolling ball referenced in claim 1 so as to enable the integration of music with the platform-tilt-controlling actions of the user/s.

17. The three or more add-ons referenced in claim 1 whereof one or more of said add-ons are platform-surface-mountable add-ons capable of emitting musical tones which can be sounded/“triggered” by the at least one rolling ball referenced in claim 1 and whereby music is integrated with the platform-tilt-controlling actions of the user/s.

18. The three or more add-ons referenced in claim 17 whereof one or more of said add-ons are displaying information whereby academic subject matter is integrated with music and the platform-tilt-controlling actions of the user/s.

19. The user/s referenced in claim 1 whereof the same are controlling the tilt of the apparatus's working surface—and thereby directing the movement of the at least one rolling ball referenced in claim 1—by means of balance while standing atop the apparatus.

20. The one or more platform-add-ons of claim 1, whereof one of these platform add-ons is supporting upon itself one or more additional platform-add-ons whereby one of these additional platform-add-ons—rather than the most foundationally supportive platform-add-on—is functioning as the primary working surface for the at least one rolling ball referenced in claim 1.
